(19) United States
(12) Patent Application Publication
(10) Pub. No.: US 2023/0156657 A1
(43) Pub. Date: May 18, 2023

(54) Multipath Single-Anchor Positioning Method and Communication Apparatus

(71) Applicant: Huawei Technologies Co., Ltd., Shenzhen (CN)

(72) Inventors: Wei Huang, Shenzhen (CN); Xueru Li, Beijing (CN); Lan Peng, Shenzhen (CN)

(21) Appl. No.: 18/158,015

(22) Filed: Jan. 23, 2023

Related U.S. Application Data
(63) Continuation of application No. PCT/CN2021/107437, filed on Jul. 20, 2021.

(30) Foreign Application Priority Data
Jul. 24, 2020 (CN) 202010725675.8
Oct. 29, 2020 (CN) 202011183286.3

(51) Int. Cl. H04W 64/00

(52) U.S. Cl. CPC H04W 64/00

(57) ABSTRACT

A method includes receiving, from a reference node, a first positioning measurement reference signal transmitted through N transmission paths, where N is an integer greater than 1; measuring first positioning information based on the first positioning measurement reference signal on a first transmission path, where the first transmission path is one of the N transmission paths; and sending first indication information and a second positioning measurement reference signal to the reference node, where the first indication information is used to indicate the first transmission path, so that the reference node measures second positioning information on the first transmission path.

### CROSS-REFERENCE TO RELATED APPLICATIONS

This is a continuation of International Patent Application No. PCT/CN2021/107437 filed on Jul. 20, 2021, which claims priority to Chinese Patent Application No. 202010725675.8 filed on Jul. 24, 2020 and Chinese Patent Application No. 202011183286.3 filed on Oct. 29, 2020. All of the aforementioned patent applications are hereby incorporated by reference in their entireties.

### TECHNICAL FIELD

This disclosure relates to the field of positioning technologies, and in particular, to a multipath single-anchor positioning method and a communication apparatus.

### BACKGROUND

Existing vertical industries including Internet of Vehicles (IoV), intelligent driving, indoor navigation and positioning, smart factory, intelligent warehousing, and the like have high requirements for high-precision positioning. In addition to these vertical industries, consumer terminal devices also have new requirements for high-precision positioning, including object positioning and tracking, precise data transmission, smart payment, smart push, smart key, and the like.

To reduce anchor deployment costs in multi-anchor positioning and a problem of insufficient anchor positioning resources, a single-anchor positioning technology is currently proposed in the industry, that is, user equipment (UE) positioning can be implemented by using only one anchor. However, in a multipath positioning environment, times of arrival and angle information of signals on different transmission paths are different. If single-anchor positioning is performed based on distance measurement information and angle information of different paths, positioning precision cannot be ensured. Therefore, how to ensure that angle information and distance information on a same path are used for UE positioning becomes a key to ensure single-anchor positioning precision.

### SUMMARY

This disclosure provides a multipath single-anchor positioning method. A reference node measures positioning information based on an indication of a to-be-positioned node and based on a same transmission path as that used by the to-be-positioned node, to resolve a problem of low positioning precision caused by inconsistency between positioning information of the to-be-positioned node and the positioning information of the reference node.

According to a first aspect, a multipath single-anchor positioning method is provided, applied to a to-be-positioned node, and the method includes receiving a first positioning measurement reference signal transmitted through N transmission paths, where the first positioning measurement reference signal is sent by a reference node, and N is an integer greater than 1, measuring first positioning information based on the first positioning measurement reference signal on a first transmission path, where the first transmission path is one of the N transmission paths, and sending first indication information and a second positioning measurement reference signal to the reference node, where the first indication information is used to indicate the first transmission path, so that the reference node measures second positioning information on the first transmission path.

According to the multipath single-anchor positioning method provided in embodiments of this disclosure, the to-be-positioned node indicates, to the reference node, a transmission path corresponding to positioning information measured by the to-be-positioned node, so that the reference node measures positioning information based on a same transmission path. This can ensure that the to-be-positioned node and the reference node complete positioning information measurement based on the same transmission path to reduce multipath impact and improve positioning accuracy when the to-be-positioned node is positioned.

With reference to the first aspect, in some implementations of the first aspect, the first transmission path is a first-arrival path or a strongest path. The first positioning measurement reference signal has a lowest transmission delay on the first-arrival path, and the first positioning measurement reference signal has smallest attenuation on the strongest path. The method further includes determining the first transmission path based on a transmission delay and/or a signal power of the first positioning measurement reference signal.

It should be understood that, because a signal transmission delay on the first-arrival path is lowest, and time of arrival information of the first-arrival path is most accurate, accurate distance measurement information can be obtained based on the first-arrival path. Moreover, because a signal strength on the strongest path is highest, and an error of angle information corresponding to the strongest path is smallest, accurate angle information can be obtained based on the strongest path.

In an implementation, if the first-arrival path and the strongest path are a same transmission path, accurate distance measurement information and angle information may be obtained based on the first-arrival path/the strongest path to ensure positioning accuracy.

In an implementation, if the first-arrival path and the strongest path are two different transmission paths, a tradeoff may be made between the first-arrival path and the strongest path according to a specific determining criterion, to select a transmission path that can reduce a positioning error for positioning information measurement.

According to the multipath single-anchor positioning method provided in embodiments of this disclosure, positioning information is measured by using the first-arrival path or the strongest path so that positioning accuracy can be ensured in a multipath environment.

With reference to the first aspect, in some implementations of the first aspect, that the first indication information is represented by 1-bit information, and the first indication information is used to indicate information about the first transmission path includes the following. When the first transmission path is the first-arrival path, the first indication information is 1. When the first transmission path is the strongest path, the first indication information is 0. Alternatively, when the first transmission path is the first-arrival path, the first indication information is 0. When the first transmission path is the strongest path, the first indication information is 1.

With reference to the first aspect, in some implementations of the first aspect, measuring first positioning information based on the first positioning measurement reference signal on a first transmission path includes recording a first arrival moment T2 of the first positioning measurement reference signal, and measuring a first angle of arrival AOA1 of the first positioning measurement reference signal.

With reference to the first aspect, in some implementations of the first aspect, the method further includes recording a first sending moment T3 of the second positioning measurement reference signal, and/or measuring a first angle of departure AOD1 of the second positioning measurement reference signal.

With reference to the first aspect, in some implementations of the first aspect, the method further includes sending third positioning information to a location service node. The third positioning information includes the first arrival moment T2 and the first sending moment T3, a difference T3−T2 between the first sending moment T3 and the first arrival moment T2, the first arrival moment T2, the first sending moment T3, and the first angle of arrival AOA1 and/or the first angle of departure AOD1, or a difference T3−T2 between the first sending moment T3 and the first arrival moment T2, and the first angle of arrival AOA1 and/or the first angle of departure AOD1.

With reference to the first aspect, in some implementations of the first aspect, the first indication information is carried in channel state information.

With reference to the first aspect, in some implementations of the first aspect, the channel state information further includes but is not limited to precoding matrix indicator (PMI) information, channel quality indicator (CQI) information, and rank indicator (RI) information of a channel matrix.

According to a second aspect, a multipath single-anchor positioning method is provided, applied to a reference node, and the method includes sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate a first transmission path, and the first transmission path is one of the N transmission paths, and measuring second positioning information on the first transmission path based on the first indication information.

According to the multipath single-anchor positioning method provided in embodiments of this disclosure, the to-be-positioned node indicates, to the reference node, a beam corresponding to measurement information used when the to-be-positioned node measures positioning information, so that the reference node completes positioning information measurement based on same measurement information. This can ensure that positioning information measured by the to-be-positioned node and the reference node corresponds to a transmission path in a same beam, to avoid multipath interference of another beam and ensure positioning information accuracy in a multipath environment.

With reference to the second aspect, in some implementations of the second aspect, the first transmission path is a first-arrival path or a strongest path. The first positioning measurement reference signal has a lowest transmission delay on the first-arrival path, and the first positioning measurement reference signal has smallest attenuation on the strongest path.

It should be understood that, because a signal transmission delay on the first-arrival path is lowest, and time of arrival information of the first-arrival path is most accurate, accurate distance measurement information can be obtained based on the first-arrival path. Moreover, because a signal strength on the strongest path is highest, and an error of angle information corresponding to the strongest path is smallest, accurate angle information can be obtained based on the strongest path.

In an implementation, if the first-arrival path and the strongest path are a same transmission path, accurate distance measurement information and angle information may be obtained based on the first-arrival path/the strongest path, to ensure positioning accuracy.

In an implementation, if the first-arrival path and the strongest path are two different transmission paths, a tradeoff may be made between the first-arrival path and the strongest path according to a specific determining criterion, to select a transmission path that can reduce a positioning error for positioning information measurement.

According to the multipath single-anchor positioning method provided in embodiments of this disclosure, positioning information is measured by using the first-arrival path or the strongest path, so that positioning accuracy can be ensured in a multipath environment.

With reference to the second aspect, in some implementations of the second aspect, that the first indication information is represented by 1-bit information, and the first indication information is used to indicate information about the first transmission path includes the following. When the first transmission path is the first-arrival path, the first indication information is 1. When the first transmission path is the strongest path, the first indication information is 0. Alternatively, when the first transmission path is the first-arrival path, the first indication information is 0. When the first transmission path is the strongest path, the first indication information is 1.

With reference to the second aspect, in some implementations of the second aspect, measuring second positioning information on the first transmission path based on the first indication information includes recording a second arrival moment T4 of the second positioning measurement reference signal, and measuring a second angle of arrival AOA2 of the second positioning measurement reference signal.

With reference to the second aspect, in some implementations of the second aspect, the method further includes recording a second sending moment T1 of the first positioning measurement reference signal, and/or measuring a second angle of departure AOD2 of the first positioning measurement reference signal.

With reference to the second aspect, in some implementations of the second aspect, the method further includes sending fourth positioning information to a location service node. The fourth positioning information includes the second sending moment T1 and the second arrival moment T4, a difference T4−T1 between the second arrival moment T4 and the second sending moment T1, the second sending moment T1, the second arrival moment T4, and the second angle of arrival AOA2 and/or the second angle of departure AOD2, or a difference T4−T1 between the second arrival moment T4 and the second sending moment T1, and the second angle of arrival AOA2 and/or the second angle of departure AOD2.

With reference to the second aspect, in some implementations of the second aspect, the first indication information is carried in channel state information.

With reference to the second aspect, in some implementations of the second aspect, the channel state information further includes but is not limited to: PMI information, CQI information, and RI information of a channel matrix.

According to a third aspect, a multipath single-anchor positioning method is provided, applied to a to-be-positioned node, and the method includes receiving a first positioning measurement reference signal transmitted through N transmission paths, where the first positioning measurement reference signal is sent by a reference node, and N is an integer greater than 1, measuring first positioning information based on first intermediate information, where the first intermediate information includes a discrete Fourier transform (DFT) base vector corresponding to a first transmission path in a precoding submatrix, and the first transmission path is one of the N transmission paths, and sending first indication information and a second positioning measurement reference signal to the reference node, where the first indication information is used to indicate the first intermediate information, so that the reference node measures second positioning information based on the first intermediate information indicated by the first indication information.

Optionally, the DFT base vector corresponding to the first transmission path in the precoding submatrix herein may be a projection vector that is associated with the first transmission path and that can project the first positioning measurement reference signal on the first transmission path to delay domain, or to delay domain and angle domain.

It should be understood that the precoding matrix in embodiments of this disclosure may be a matrix including a frequency domain DFT vector or a spatial domain and frequency domain DFT vector selected by the to-be-positioned node from a basic frequency domain vector set or a basic spatial domain and frequency domain vector set.

With reference to the third aspect, in some implementations of the third aspect, that the first indication information is used to indicate the first intermediate information includes the following. The first indication information includes identification information of the DFT base vector corresponding to the first transmission path in the precoding submatrix.

With reference to the third aspect, in some implementations of the third aspect, that the first indication information includes identification information of the DFT base vector corresponding to the first transmission path in the precoding submatrix includes the following. The first indication information includes index information of the DFT base vector.

With reference to the third aspect, in some implementations of the third aspect, the precoding submatrix is a submatrix including a frequency domain DFT. Alternatively, the precoding submatrix is a submatrix including a spatial domain and frequency domain two-dimensional DFT base vector.

With reference to the third aspect, in some implementations of the third aspect, the first transmission path is a first-arrival path or a strongest path identified after projection of the DFT base vector. The first positioning measurement reference signal has a lowest transmission delay on the first-arrival path, and the first positioning measurement reference signal has smallest attenuation on the strongest path. The method further includes determining the first transmission path based on a transmission delay and/or a signal power of the first positioning measurement reference signal.

With reference to the third aspect, in some implementations of the third aspect, obtaining the first positioning information based on the first positioning measurement reference signal on the first transmission path includes recording an arrival moment T2 of the first positioning measurement reference signal, and measuring an angle of arrival AOA1 of the first positioning measurement reference signal.

With reference to the third aspect, in some implementations of the third aspect, the method further includes recording a sending moment T3 of the second positioning measurement reference signal, and/or measuring an angle of departure AOD1 of the second positioning measurement reference signal.

With reference to the third aspect, in some implementations of the third aspect, the method further includes sending third positioning information to a location service node. The third positioning information includes the arrival moment T2 and the sending moment T3, a difference T3−T2 between the sending moment T3 and the arrival moment T2, the arrival moment T2, the sending moment T3, and the angle of arrival AOA1 and/or the angle of departure AOD1, or a difference T3−T2 between the sending moment T3 and the arrival moment T2, and the angle of arrival AOA1 and/or the angle of departure AOD1.

With reference to the third aspect, in some implementations of the third aspect, the first indication information is carried in channel state information.

With reference to the third aspect, in some implementations of the third aspect, the channel state information further includes but is not limited to: PMI information, CQI information, and RI information of a channel matrix.

According to a fourth aspect, a multipath single-anchor positioning method is provided, applied to a reference node, and the method includes sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate first intermediate information, the first intermediate information includes a DFT base vector corresponding to a first transmission path in a precoding submatrix, and the first transmission path is one of the N transmission paths, and measuring second positioning information based on the first indication information by using the first intermediate information.

With reference to the fourth aspect, in some implementations of the fourth aspect, that the first indication information is used to indicate the first intermediate information includes the following. The first indication information includes identification information of the DFT base vector corresponding to the first transmission path in the precoding submatrix.

With reference to the fourth aspect, in some implementations of the fourth aspect, that the first indication information includes identification information of the DFT base vector corresponding to the first transmission path in the precoding submatrix includes the following. The first indication information includes index information of the DFT base vector.

With reference to the fourth aspect, in some implementations of the fourth aspect, the precoding submatrix is a submatrix including a frequency domain DFT base vector. Alternatively, the precoding submatrix is a submatrix including spatial domain and frequency domain two-dimensional DFT base vectors.

With reference to the fourth aspect, in some implementations of the fourth aspect, the first transmission path is a first-arrival path or a strongest path identified after projection of the DFT. The first positioning measurement reference signal has a lowest transmission delay on the first-arrival path, and the first positioning measurement reference signal has smallest attenuation on the strongest path.

With reference to the fourth aspect, in some implementations of the fourth aspect, measuring second positioning information based on the first measurement information includes recording an arrival moment T4 of the second positioning measurement reference signal, and measuring an angle of arrival AOA2 of the second positioning measurement reference signal.

With reference to the fourth aspect, in some implementations of the fourth aspect, the method further includes recording a sending moment T1 of the first positioning measurement reference signal, and/or measuring an angle of departure AOD2 of the first positioning measurement reference signal.

With reference to the fourth aspect, in some implementations of the fourth aspect, the method further includes sending fourth positioning information to a location service node. The fourth positioning information includes second time information. Alternatively, the fourth positioning information includes second time information and second angle information. The second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal. The second angle information includes the angle of arrival AOA2 of the second positioning measurement reference signal, and/or the angle of departure AOD2 of the first positioning measurement reference signal.

With reference to the fourth aspect, in some implementations of the fourth aspect, the first indication information is carried in channel state information.

With reference to the fourth aspect, in some implementations of the fourth aspect, the channel state information further includes but is not limited to: PMI information, CQI information, and RI information of a channel matrix.

According to a fifth aspect, a multipath single-anchor positioning method is provided, applied to a location service node, and the method includes receiving third positioning information sent by a to-be-positioned node and fourth positioning information sent by a reference node, where the third positioning information and the fourth positioning information respectively include positioning information obtained by the to-be-positioned node based on a first transmission path and positioning information obtained by the reference node based on the first transmission path, or the third positioning information and the fourth positioning information respectively include positioning information obtained by the to-be-positioned node based on same first intermediate information and positioning information obtained by the reference node based on the same first intermediate information, and the first intermediate information includes a DFT base vector, and positioning the to-be-positioned node based on the third positioning information and the fourth positioning information.

With reference to the fifth aspect, in some implementations of the fifth aspect, the third positioning information includes first time information. Alternatively, the third positioning information includes first time information and first angle information. The first time information includes an arrival moment T2 of a first positioning measurement reference signal and a sending moment T3 of a second positioning measurement reference signal, or a difference T3−T2 between the sending moment T3 of the second positioning measurement reference signal and the arrival moment T2 of the first positioning measurement reference signal. The first positioning measurement reference signal is sent by the reference node, and the second positioning measurement reference signal is sent by the to-be-positioned node. The first angle information includes an angle of arrival AOA1 of the first positioning measurement reference signal, and/or an angle of departure AOD1 of the second positioning measurement reference signal.

With reference to the fifth aspect, in some implementations of the fifth aspect, the fourth positioning information includes second time information. Alternatively, the fourth positioning information includes second time information and second angle information. The second time information includes an arrival moment T4 of the second positioning measurement reference signal and a sending moment T1 of the first positioning measurement reference signal, or a difference T4−T1 between the arrival moment T4 of the second positioning measurement reference signal and the sending moment T1 of the first positioning measurement reference signal. The first positioning measurement reference signal is sent by the reference node, and the second positioning measurement reference signal is sent by the to-be-positioned node. The second angle information includes an angle of arrival AOA2 of the second positioning measurement reference signal, and/or an angle of departure AOD2 of the first positioning measurement reference signal.

With reference to the fifth aspect, in some implementations of the fifth aspect, obtaining positioning information of the to-be-positioned node based on the third positioning information and the fourth positioning information includes determining a round trip time based on the first time information and the second time information, calculating the positioning information of the to-be-positioned node based on the round trip time, the AOA1 in the first angle information, and the AOD2 in the second angle information, calculating the positioning information of the to-be-positioned node based on the round trip time, the AOD1 in the first angle information, and the AOA2 in the second angle information, calculating the positioning information of the to-be-positioned node based on the round trip time, a weighted value of the AOA1 and the AOD1 in the first angle information, and the AOA2 in the second angle information, calculating the positioning information of the to-be-positioned node based on the round trip time, the weighted value of the AOA1 and the AOD1 in the first angle information, and the AOD2 in the second angle information, calculating the positioning information of the to-be-positioned node based on the round trip time, the weighted value of the AOA1 and the AOD1 in the first angle information, and a weighted value of the AOA2 and the AOD2 in the second angle information, calculating the positioning information of the to-be-positioned node based on the round trip time, the AOA1 in the first angle information, and the weighted value of the AOA2 and the AOD2 in the second angle information, or calculating the positioning information of the to-be-positioned node based on the round trip time, the AOD1 in the first angle information, and the weighted value of the AOA2 and AOD2 in the second angle information.

According to a sixth aspect, a communication apparatus is provided, including at least one processor, a communication interface, and a memory. The communication interface is used for information exchange between the communication apparatus and another communication apparatus, the memory stores computer program instructions, and when the computer program instructions are executed by the at least one processor, the communication apparatus is enabled to implement a function of the method according to any one of the implementations of the first aspect to the fifth aspect on any one of the following nodes: the to-be-positioned node, the reference node, or the location service node.

According to a seventh aspect, a computer program readable storage medium is provided. The computer-readable storage medium has program instructions, and when the program instructions are directly or indirectly executed, a function of the method according to any one of the implementations of the first aspect to the fifth aspect on any one of the following nodes is implemented: the to-be-positioned node, the reference node, or the location service node.

According to an eighth aspect, a chip system is provided. The chip system includes at least one processor, and when program instructions are executed by the at least one processor, a function of the method according to any one of the implementations of the first aspect to the fifth aspect on any one of the following apparatuses is implemented: the to-be-positioned node, the reference node, or the location service node.

According to a ninth aspect, a computer program is provided. When the computer program is executed by at least one processor, a function of the method according to any one of the implementations of the first aspect to the fifth aspect on any one of the following nodes is implemented: the to-be-positioned node, the reference node, or the location service node.

According to a tenth aspect, a computer program product is provided. When the computer program is executed by at least one processor, a function of the method according to any one of the implementations of the first aspect to the fifth aspect on any one of the following nodes is implemented: the to-be-positioned node, the reference node, or the location service node.

### BRIEF DESCRIPTION OF DRAWINGS

FIG. 1 is a schematic diagram of angle information and distance information in a multipath scenario according to an embodiment of this disclosure;

FIG. 2 is a schematic diagram of an architecture of a multipath single-anchor positioning system according to an embodiment of this disclosure;

FIG. 3 is a schematic flowchart of a multipath single-anchor positioning method according to an embodiment of this disclosure;

FIG. 4 is a schematic flowchart of another multipath single-anchor positioning method according to an embodiment of this disclosure;

FIG. 5 is a schematic flowchart of still another multipath single-anchor positioning method according to an embodiment of this disclosure;

FIG. 6 is a schematic diagram of a structure of channel state information according to an embodiment of this disclosure;

FIG. 7A, FIG. 7B, and FIG. 7C are schematic diagrams of another structure of channel state information according to an embodiment of this disclosure;

FIG. 8 is a schematic diagram of a structure of a communication node according to an embodiment of this disclosure;

FIG. 9 is a schematic diagram of a structure of another communication node according to an embodiment of this disclosure;

FIG. 10 is a schematic diagram of a structure of still another communication node according to an embodiment of this disclosure; and

FIG. 11 is a schematic diagram of a structure of a communication apparatus according to an embodiment of this disclosure.

### DESCRIPTION OF EMBODIMENTS

The following describes embodiments of this disclosure with reference to the accompanying drawings in embodiments of this disclosure. Terms used in implementations of embodiments of this disclosure are merely used to explain specific embodiments of this disclosure, and are not intended to limit this disclosure. In the descriptions of embodiments of this disclosure, “I” means “or” unless otherwise specified. For example, AB may represent A or B. In this specification, “and/or” describes only an association relationship between associated objects and represents that three relationships may exist. For example, A and/or B may represent the following three cases: only A exists, both A and B exist, and only B exists. In addition, in the descriptions of embodiments of this disclosure, “a plurality of” means two or more than two, and “multipath” means two or more paths.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features.

The technical solutions in embodiments of this disclosure may be applied to various communication systems, for example, a cellular positioning system, a wireless local area network (WLAN) system, a Long-Term Evolution (LTE) system, an LTE frequency-division duplex (FDD) system, an LTE time-division duplex (TDD) system, a universal mobile telecommunications system (UMTS), a Worldwide Interoperability for Microwave Access (WIMAX) communication system, a 5th generation (5G) mobile communication system, or a New Radio (NR) system.

The to-be-positioned node in embodiments of this disclosure is a communication apparatus having a wireless transceiver function and an NR transmission capability, and may represent a redistribution point or a communication endpoint (for example, a terminal device). The to-be-positioned node may be, for example, UE, a terminal device, a terminal, a wireless communication device, a user agent, or a user apparatus. Alternatively, the to-be-positioned node may be a cellular phone, a cordless phone, a Session Initiation Protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal device in a 5G cellular network, or a terminal device in a public land mobile network (PLMN). From a perspective of a product form, the to-be-positioned node in embodiments of this disclosure may be a device that supports an NR air interface, especially a terminal device such as a mobile phone, a computer, a tablet, a band, a smartwatch, a data card, or a sensor. In embodiments of this disclosure, an example in which the to-be-positioned node is UE is used for description. However, this is not limited in this disclosure.

The reference node in embodiments of this disclosure may be used as a positioning anchor to position the UE. From a perspective of a function, the reference node is a device that has a control function, can configure positioning measurement resources, and supports an NR connection. The reference node has a multi-antenna capability (a quantity of antennas is greater than or equal to 3). From a perspective of a product form, the reference node in this disclosure may be, for example, a next generation node base station (gNB) in a 5G mobile communication system, and may be a macro base station or a micro base station. Alternatively, the reference node may be a pico base station (pico), a femto base station (femto), a transmission point (TP), a relay, or the like. In embodiments of this disclosure, an example in which the reference node is a gNB is used for description. However, this is not limited in this disclosure.

The location service node in embodiments of this disclosure may be a core network apparatus, for example, a location server (LCS), including a location management function (LMF) entity, and is configured to perform positioning estimation based on data reported by the to-be-positioned node and positioning information reported by the reference node.

With development of intelligence, increasingly more scenarios need to rely on accurate positioning. The 3rd Generation Partnership Project (3GPP) standard “TS 22.804 positioning service performance requirement in vertical domain” defines eight types of positioning scenarios. Positioning requirements of these positioning scenarios include absolute positioning and relative positioning requirements. Positioning precision requirements range from 5 meters (m) to 20 centimeters (cm), and reliability requirements range from 90% to 99.9%. In the Rel-17 NR Positioning study item (SI) of the 3GPP RAN #86 meeting, the objectives are as follows. In a general commercial scenario, the positioning precision meets submeter-level positioning precision, and a positioning delay is 100 milliseconds (ms). In the Industrial Internet of Things (HOT), the positioning precision needs to meet a requirement of 20 cm, and the positioning delay needs to meet a requirement of 10 ms. Based on this requirement, the 3GPP standard actively promotes standardization, including a radio access technology (RAT) dependent positioning based on a 3GPP cellular network, a global navigation satellite system (GNSS), and a positioning technology based on a non-3GPP terrestrial network, for example, WI-FI positioning, BLUETOOTH positioning, terrestrial beacon system (TB S) positioning, ultra wideband (UWB) positioning, and hybrid positioning technologies.

No matter which positioning technology is used, multipath interference, a clock synchronization error, and rich positioning anchors (three or more anchors) may become key factors that limit positioning precision. A synchronization error in a positioning process includes a synchronization error between a plurality of anchors such as a base station/satellite/access point (AP), and also includes a synchronization error between an anchor (base station/satellite/access point (AP)) and to-be-positioned UE. In an observed time difference of arrival (OTDOA) technology, the UE measures an observed time difference of arrival of different anchors, which can effectively resolve a problem of a synchronization deviation between the positioning anchor and the to-be-positioned UE. However, the anchors need to be strictly synchronized. Otherwise, the positioning precision is very poor. A multi-round trip time (multi-RTT) is used to estimate RTTs between the UE and the plurality of anchors by sending and receiving signals, and estimate a UE location according to a trilateration algorithm. An advantage of using the RTT to estimate a distance between the anchor and the UE for positioning is that there is no need to consider a synchronization error between anchors. However, a disadvantage is that an additional positioning measurement reference signal needs to be used, and consequently, resource overheads are increased.

In addition, because most existing positioning technologies perform location estimation according to a trilateration algorithm or a triangulation location algorithm, three or more related anchors are needed. This may cause an increase in deployment costs and insufficient anchors under a constraint of frequency efficiency. Cellular positioning is used as an example. Multi-anchor positioning has two restrictions. (1) Cell spectrum maximization (co-channel interference control) considered during base station deployment. Therefore, only one or two cells can be seen in a large quantity of areas. (2) Uncertainty of a base station location (an antenna location). Therefore, if single-anchor/single-station positioning can be implemented, it is very beneficial to usability and costs of cellular positioning.

In addition, a multipath effect and signal shielding are main factors that affect measurement precision of a time of arrival (TOA)/a time difference of arrival (TDOA). Although a wider bandwidth of a wireless positioning system indicates a higher time resolution of time domain of the wireless positioning system, and a higher resolution obtained after correlation processing is performed on a multipath signal, a positioning error problem caused by a plurality of paths cannot be avoided. Due to multipath impact during signal propagation, a receiver cannot distinguish between line of sight (LOS) and non-LOS (NLOS) signals, and a related peak value deviates during signal processing, causing TOA estimation errors. Alternatively, a receiver receives reflected, refracted, and diffracted radio signals because a direct path is blocked during signal propagation, causing a TOA measurement deviation. Alternatively, because a signal of a direct path is weak, a related processing result is lower than a threshold and is unavailable, and consequently, accurate TOA data cannot be obtained.

To eliminate impact of the multipath effect on positioning, related technologies are as follows. (1) Improve of sensitivity and a dynamic range of a system. Because a radio frequency front-end with a large dynamic range has a higher tolerance to noise interference, a multipath error is reduced. However, in this method, requirements on device hardware is high. (2) Identify of an LOS path and an NLOS path of a channel, and perform weighted processing during location calculation. However, in this method, a receive end needs to be able to accurately identify the LOS/NLOS path. (3) Correct a positioning error caused by the NLOS path. However, in this method, angles at which an obstacle reflects, refracts, and diffracts a signal need to be learned of. An optical principle and plane geometry are used to convert an NLOS propagation path into an equivalent LOS propagation.

To eliminate the impact of the multipath effect on positioning and resolve a problem of insufficient multi-anchor positioning resources, a single-anchor positioning technology is proposed in the industry. To be specific, only one anchor is needed to implement UE positioning, and a plurality of anchors is not needed to participate in positioning at a same time. Therefore, problems of a synchronization error between anchors and insufficient anchor resources are eliminated, and network deployment costs can be reduced. Simultaneously localization and mapping (SLAM) is a single-anchor positioning technology that is widely studied. When an environment location cannot be determined by using a location of a to-be-positioned target, the to-be-positioned target creates a map, and performs autonomous positioning and navigation by using the map. An advantage of the SLAM is that a relative position and a reflector position can be calculated by using a single node, and there is no need to perform coordination between a plurality of nodes in OTDOA positioning, to implement single-anchor positioning. In addition, it is proposed by some researchers that the UE location is estimated by using an angle of arrival (AOA) and a TOA of the LOS path and a reflection path, to assist single-anchor positioning by using multipath information. In addition, simultaneously position and reflector estimation (SPRE) is also a typical single-anchor positioning method. According to an SPRE algorithm, estimation of the UE location and the reflector location may be divided into the following three steps. 1: First, rough location information of the UE is obtained by using a measurement AOA and a TOA of the LOS path. 2: The reflector positions are estimated based on the estimated rough position, and are refined by using an average filtering method. 3: Current UE location estimation is updated based on the refined reflector locations.

In the single-anchor positioning method assisted by the multipath, a premise for implementing high-precision positioning includes the following. 1: A receive end and a transmit end can identify an LOS path and an NLOS path, and perform TOA measurement or RTT measurement based on the identified LOS path. 2: At least one of the transmit end and the receive end needs to have a multi-antenna capability (>3 antennas), to estimate the AOA or an angle of departure (AOD) and perform hybrid positioning based on the TOA on the LOS path. However, in an actual system, during multipath identification, a conventional multiple signal classification (MUSIC) algorithm and an estimation of signal parameters via rotation invariant technique (ESPRIT) algorithm have a bandwidth problem of the transmit end and the receive end and a noise problem. As a result, non-ideal wide/narrow beams affect AOA/AOD estimation precision. In addition, in a distance metric according to a geometric positioning algorithm, a first-arrival path with a lowest signal transmission delay usually represents a distance from an anchor to a to-be-measured object. However, in an actual scenario, because the LOS path is blocked for some reasons, the NLOS path is estimated to be the LOS path, and consequently, a positioning estimation error is large.

In an ideal multipath environment, without considering impact of factors such as obstacles in a transmission path, the first-arrival path is usually a direct path. The first-arrival path corresponds to the lowest signal transmission delay (a smallest TOA) and a highest signal strength. If the first-arrival path is used to measure angle information of positioning and positioning information, the obtained positioning information is most accurate.

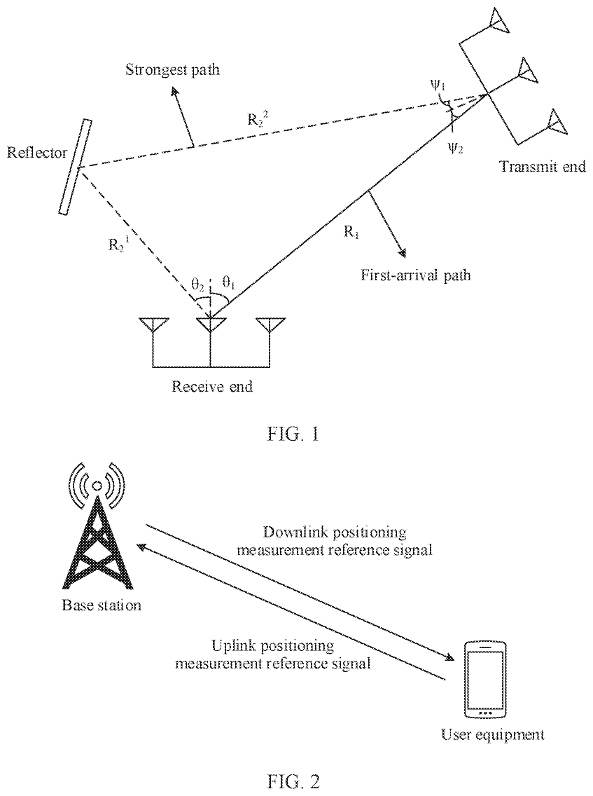

However, in an actual multipath environment, due to impact of an obstacle, a signal of the first-arrival path is greatly attenuated during transmission, so that a signal strength of the first-arrival path is not necessarily highest. In this case, the first-arrival path and a signal strongest path (which is referred to as the strongest path below) are two different paths. For example, FIG. 1 is a schematic diagram of angle information and distance information respectively corresponding to a first-arrival path and a strongest path. θ₁ is an AOD of the first-arrival path, φ₁ is an AOA of the first-arrival path, and R₁ is distance information corresponding to a TOA. θ₂ is an AOD of the strongest path with smallest signal attenuation, φ₂ is an AOA of the strongest path, R₂¹ corresponds to a distance between a transmit end and a reflector in the strongest path, and R₂² corresponds to a distance between the reflector and a receive end in the strongest path.

It should be understood that a higher signal strength indicates a smaller corresponding angle estimation error, and therefore more accurate angle information can be obtained based on the strongest path. A smaller TOA indicates a closer direct path, and therefore more accurate distance information can be obtained based on the first-arrival path. As described in the background, in a multipath positioning environment, if consistency of distance measurement information and angle information between an anchor and UE cannot be ensured, precision of single-anchor positioning cannot be ensured. Therefore, in single-anchor positioning in a multipath scenario, to obtain more accurate positioning information, consistency of distance information measurement and angle information measurement during positioning measurement needs to be maintained, that is, distance measurement and angle measurement are performed based on a same path. Therefore, selection need to be performed between the first-arrival path and the strongest path, and a tradeoff is made between accurate distance information measurement and accurate angle information measurement to implement accurate positioning.

To meet the foregoing requirement, embodiments of this disclosure provide a multipath single-anchor positioning method. A to-be-positioned node indicates, to a reference node, which path corresponds to positioning information measured by the to-be-positioned node, so that the reference node and the to-be-positioned node also measure positioning information based on a same path. This ensures consistency between distance information and angle information and implements high-precision positioning.

For example, FIG. 2 is a schematic diagram of an architecture of a multipath single-anchor positioning system according to an embodiment of this disclosure.

In some embodiments, a reference node may be a positioning anchor in a positioning process, and can send, to a target node, a downlink positioning measurement reference signal, for example, a positioning reference signal (PRS), a channel state information reference signal (CSI-RS), or a time/frequency tracking reference signal (TRS).

In some embodiments, a to-be-positioned node may send an uplink positioning measurement reference signal, for example, a sounding reference signal (SRS). The to-be-positioned node may further support an NR transmission capability.

In some embodiments, the system architecture may further include a location service node. The location service node may initiate a single-anchor positioning procedure based on a request of the to-be-positioned node, and position the to-be-positioned node based on positioning information reported by the to-be-positioned node and the reference node. In this embodiment of this disclosure, the location service node may be an LMF entity in a location server.

For ease of understanding, in the system architecture shown in FIG. 2, the to-be-positioned node is user equipment, and the reference node is a base station. In addition, the multipath single-anchor positioning method provided in embodiments of this disclosure may be applied to a plurality of terminal device positioning scenarios. For example, in an outdoor scenario, a user positions a location of the user. This is not limited in this disclosure.

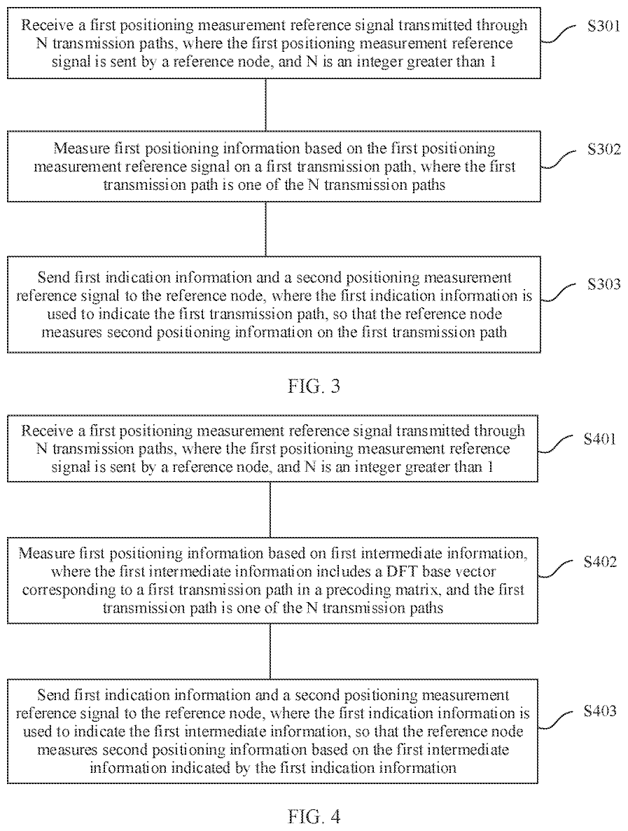

For example, FIG. 3 is a schematic flowchart of a multipath single-anchor positioning method according to an embodiment of this disclosure. The method may be applied to the system architecture shown in FIG. 2, and may include the following steps. The steps may be performed by a to-be-positioned node.

S301: Receive a first positioning measurement reference signal transmitted through N transmission paths, where the first positioning measurement reference signal is sent by a reference node, and N is an integer greater than 1.

In some embodiments, the reference node sends a positioning measurement reference signal. The positioning measurement reference signal may include but is not limited to one or more of a PRS, a CSI-RS, and a TRS.

It should be understood that multipath propagation of a signal is caused due to scattering of an electromagnetic wave by an atmosphere, reflection and refraction of an electromagnetic wave by an ionosphere, and reflection of an electromagnetic wave by a surface object like a mountain or a building in an actual environment. The N transmission paths herein are a plurality of transmission paths in a multipath propagation environment. The positioning measurement reference signal sent by the reference node may be separately transmitted to the to-be-positioned node by using the N transmission paths.

In some embodiments, the N output paths include a first-arrival path and a strongest path. The first-arrival path is a transmission path on which the positioning measurement reference signal has a lowest delay. The strongest path is a path on which the positioning measurement reference signal has smallest attenuation. In other words, the strongest path is a path on which the positioning measurement reference signal has a highest signal power.

In some embodiments, when sending the first positioning measurement reference signal, the reference node records a sending moment T1 of the first positioning measurement reference signal. Optionally, the sending moment T1 corresponds to a moment at which the first positioning measurement reference signal is sent by a transmit antenna of the reference node.

In some embodiments, the reference node may further send time-frequency domain indication information to the to-be-positioned node, to indicate the to-be-positioned node to receive the first positioning measurement reference signal in specified time-frequency domain.

In some embodiments, the to-be-positioned node receives, in the specified time-frequency domain, the first positioning measurement reference signal sent by the reference node. In addition, the to-be-positioned node records an arrival moment T2 of the first positioning measurement reference signal. Optionally, the arrival moment T2 corresponds to a moment at which the first positioning measurement reference signal arrives at a receive antenna of the to-be-positioned node.

For example, the to-be-positioned node may record an arrival moment of the first positioning measurement reference signal on each transmission path. Alternatively, the to-be-positioned node may record at least arrival moments of the first positioning measurement reference signal on the first-arrival path and the strongest path.

S302: Measure first positioning information based on the first positioning measurement reference signal on a first transmission path, where the first transmission path is one of the N transmission paths.

The first transmission path is any one of the N transmission paths. Optionally, the first transmission path is the first-arrival path. Alternatively, the first transmission path is the strongest path. Alternatively, the first transmission path may be both the first-arrival path and the strongest path.

In some embodiments, the first positioning information includes but is not limited to: the arrival moment T2 of the first positioning measurement reference signal, an angle of arrival AOA1 of the first positioning measurement reference signal, and a reference signal receiving power (RSRP) of the first positioning measurement reference signal.

S303: Send first indication information and a second positioning measurement reference signal to the reference node, where the first indication information is used to indicate the first transmission path, so that the reference node measures second positioning information on the first transmission path.

In some embodiments, the second positioning measurement reference signal is an uplink measurement reference signal, and may include but is not limited to an SRS.

In some embodiments, the first indication information may be, for example, channel multipath indicator (CMPI) information. The first indication information may be carried in a channel state information (CSI) report.

For example, when the to-be-positioned node has a strong antenna capability (for example, a quantity of antennas is greater than or equal to 3) and a strong processing capability (for example, a calculation capability), so that the to-be-positioned node has a multipath identification capability, the first indication information may be indication information of the first transmission path, which is used to indicate a transmission path corresponding to the measured first positioning information.

It should be understood that the first indication information is sent to the reference node, so that the reference node can measure positioning information based on a same transmission path. This ensures that positioning information measured by the reference node and the to-be-positioned node is positioning information on a same transmission path, improves accuracy of the positioning information, and improves positioning precision.

In some embodiments, the to-be-positioned node may further obtain an angle of departure AOD1 of the second positioning measurement reference signal.

In some embodiments, the to-be-positioned node may report third positioning information to a location service node. The third positioning information is used by the location service node to position the to-be-positioned node. For example, the third positioning information includes first time information. Alternatively, the third positioning information includes first time information and first angle information. The first time information includes the arrival moment T2 of the first positioning measurement reference signal and a sending moment T3 of the second positioning measurement reference signal. Alternatively, the first time information includes a difference T3−T2 between the sending moment T3 of the second positioning measurement reference signal and the arrival moment T2 of the first positioning measurement reference signal. The first angle information may include the angle of arrival AOA1 of the first positioning measurement reference signal, and/or the angle of departure AOD1 of the second positioning measurement reference signal.

In some embodiments, the reference node receives the first indication information and a second positioning measurement reference signal that are sent by the to-be-positioned node. The first indication information and the second positioning measurement reference signal may be sent simultaneously, or may not be sent simultaneously. When the first indication information and the second positioning measurement reference signal are not sent simultaneously, a time sequence of sending the first indication information and the second positioning measurement reference signal is not limited in this disclosure. For example, the reference node may receive a CSI report sent by the to-be-positioned node, and learn, based on the CMPI indication information included in the CSI report, the transmission path corresponding to the first positioning information measured by the to-be-positioned node.

In some embodiments, the reference node measures, based on the indication information of the first transmission path, the second positioning information corresponding to the first transmission path.

The second positioning information includes an arrival moment T3 of the second positioning measurement reference signal and an angle of arrival AOA2 of the second positioning measurement reference signal.

In some embodiments, the reference node receives, in the specified time-frequency domain, the second positioning measurement reference signal sent by the to-be-positioned node. In addition, the reference node records the arrival moment T4 of the second positioning measurement reference signal. Optionally, the arrival moment T4 corresponds to a moment at which the second positioning measurement reference signal arrives at a receive antenna of the reference node.

For example, the reference node may record an arrival moment of the second positioning measurement reference signal on each transmission path. Alternatively, the reference node may record at least arrival moments of the second positioning measurement reference signal on the first-arrival path and the strongest path.

In some embodiments, the reference node reports fourth positioning information to the location service node. The fourth positioning information is used by the location service node to position the to-be-positioned node. For example, the fourth positioning information includes second time information. Alternatively, the fourth positioning information includes second time information and second angle information. The second time information includes the arrival moment T4 of the second positioning measurement reference signal and the sending moment T1 of the first positioning measurement reference signal. Alternatively, the second time information includes a difference T4−T1 between the sending moment T4 of the second positioning measurement reference signal and the sending moment T1 of the first positioning measurement reference signal. The first angle information includes the angle of departure AOA2 of the first positioning measurement reference signal, and/or an angle of arrival AOD2 of the second positioning measurement reference signal.

According to the multipath single-anchor positioning method provided in this embodiment of this disclosure, indication information of a transmission path corresponding to positioning information measured by a to-be-positioned node is sent to a reference node, so that the reference node can measure positioning information based on a same transmission path. This ensures that the positioning information measured by the reference node and the to-be-positioned node is positioning information on a same transmission path, and improves accuracy of the positioning information and positioning precision.

For example, FIG. 4 is a schematic flowchart of another multipath single-anchor positioning according to an embodiment of this disclosure. The method may be applied to the system architecture shown in FIG. 2, and may include the following steps. The steps may be performed by a to-be-positioned node.

S401: Receive a first positioning measurement reference signal transmitted through N transmission paths, where the first positioning measurement reference signal is sent by a reference node, and N is an integer greater than 1.

S402: Measure first positioning information based on first intermediate information, where the first intermediate information includes a DFT base vector corresponding to a first transmission path in a precoding submatrix, and the first transmission path is one of the N transmission paths.

S403: Send first indication information and a second positioning measurement reference signal to the reference node, where the first indication information is used to indicate the first intermediate information, so that the reference node measures second positioning information based on the first intermediate information indicated by the first indication information.

It should be understood that, different from the multipath single-anchor positioning method shown in FIG. 3, the method shown in FIG. 4 is applicable to a scenario in which the to-be-positioned node cannot identify a plurality of paths. For example, when the to-be-positioned node has a weak antenna capability (for example, a quantity of antennas is less than 3) or a weak processing capability (for example, a calculation capability), the to-be-positioned node cannot directly perform multipath identification on a signal according to a super-resolution algorithm or a multi-signal classification algorithm. To avoid repetition, the following describes only a difference between the embodiment in FIG. 4 and the embodiment in FIG. 3.

It can be learned from the foregoing analysis that, when the to-be-positioned node cannot identify a plurality of paths, the to-be-positioned node cannot directly indicate the reference node to select which transmission path for measuring positioning information. In this case, the to-be-positioned node cannot directly measure the positioning information based on a transmission path. Therefore, in this case, the to-be-positioned node may measure the first positioning information based on measurement information corresponding to a DFT base vector, and indicate the reference node to measure the second positioning information based on same measurement information, so that measurement of the first positioning information and the second positioning information is completed by using the DFT base vector in a same precoding submatrix. This ensures positioning precision in a multipath environment.

The DFT base vector in this example of this disclosure may also be referred to as a DFT beam.

In some embodiments, in the step S402, the first intermediate information may include the DFT base vector corresponding to the first transmission path in the precoding submatrix. The precoding submatrix is a precoding submatrix including a DFT base vector projected onto the first transmission path. It should be understood that the precoding matrix in this embodiment of this disclosure may be a matrix including a frequency domain DFT vector or a spatial domain and frequency domain DFT vector selected by the to-be-positioned node from a basic frequency domain vector set or a basic spatial domain and frequency domain vector set.

It should be further understood that the DFT base vector corresponding to the first transmission path in the precoding submatrix in this embodiment of this disclosure may be a projection vector that is associated with the first transmission path and that can project the first positioning measurement reference signal on the first transmission path to delay domain, or to delay domain and angle domain. In other words, the first positioning measurement signal on the first transmission path may be projected to the delay domain by using a frequency domain DFT base vector. Alternatively, the first positioning measurement signal on the first transmission path may be separately projected to the delay domain and the angle domain by using a frequency domain two-dimensional DFT base vector and a spatial domain two-dimensional DFT base vector.

In some embodiments, in the step S403, the first indication information may be used to indicate the first intermediate information. For example, the first indication information may be used to indicate the DFT base vector corresponding to the first transmission path.

For example, the first indication information may include identification information of the DFT base vector. Alternatively, the first indication information may include index information of the DFT base vector, for example, index information of a frequency domain DFT base vector, or index information of a spatial domain and frequency domain two-dimensional DFT base vector.

According to the multipath single-anchor positioning method provided in this embodiment of this disclosure, first indication information is sent to a reference node, so that the reference node can measure positioning information based on a DFT base vector in a same precoding submatrix. This ensures that positioning information measured by the reference node and a to-be-positioned node is positioning information corresponding to a transmission path under projection of a same DFT base vector, improves accuracy of the positioning information, and improves positioning precision.

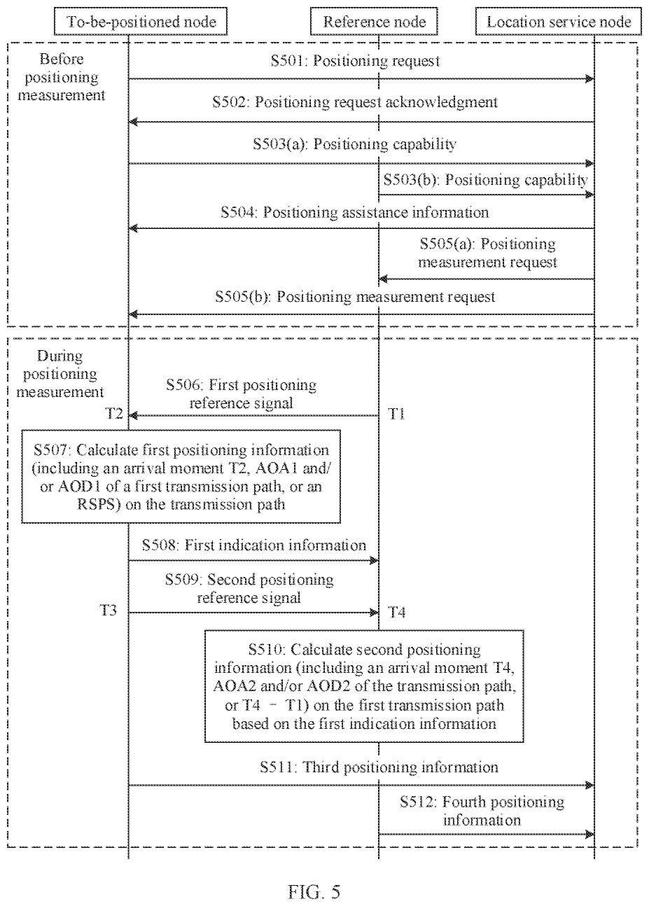

For example, FIG. 5 is a schematic flowchart of interaction between a to-be-positioned node, a reference node, and a location service node in a multipath single-anchor positioning process according to an embodiment of this disclosure.

For ease of understanding, the multipath single-anchor positioning process provided in this embodiment of this disclosure is further divided into two phases. A phase 1 is an information configuration phase before positioning measurement, and a phase 2 is a positioning information measurement and reporting phase.

For example, the phase 1 includes the following steps.

S501: The to-be-positioned node sends a positioning request to the location service node.

The to-be-positioned node may send a positioning request message to the location service node, to request positioning from the location service node.

S502: The location service node sends a positioning request acknowledgment information to the to-be-positioned node.

After receiving the positioning request, the location serving node (for example, an LMF in an LCS) starts to initiate a single-anchor or single-base station cellular positioning procedure.

In some embodiments, after determining single-anchor positioning, the location service node may request to query a positioning capability of the to-be-positioned node. Further, the location service node may send positioning capability request information to the to-be-positioned node, and the positioning capability request information may be included in the positioning request acknowledgment message.

In some embodiments, the location service node may further request to query a positioning capability of the reference node. Further, the location service node may send the positioning capability request information to the to-be-positioned node.

The positioning capability herein may include an antenna capability, for example, a quantity of antennas. It should be understood that when the antenna capability of the reference node is strong, for example, when the quantity of antennas is greater than or equal to 3, more accurate angle information may be obtained based on a received positioning measurement reference signal. Similarly, if the antenna capability of the to-be-positioned node is strong, more accurate angle information may be obtained, to improve accuracy of the positioning information.

S503(a): The to-be-positioned node sends the positioning capability to the location service node.

For example, the to-be-positioned node feeds back the positioning capability of the to-be-positioned node to the location service node in response to the positioning capability request of the location service node.

S503(b): The reference node sends the positioning capability to the location service node.

For example, the reference node feeds back the positioning capability of the reference node to the location service node in response to the positioning capability request of the location service node.

In some embodiments, the location service node may select a proper single-anchor positioning method based on the positioning capabilities respectively reported by the to-be-positioned node and the reference node. For example, when both the to-be-positioned node and the reference node have strong antenna capabilities (a quantity of antennas is greater than or equal to 3), it is determined that an RTT+AOD hybrid positioning method, an RTT+AOA hybrid positioning method, a TOA+AOD hybrid positioning method, a TOA+AOA hybrid positioning method, or the like is used. When the reference node has a strong positioning capability, but the to-be-positioned node has a weak positioning capability, a hybrid positioning method of an RTT+an AOA/AOD calculated by the reference node, or a hybrid positioning method of a TOA+an AOA/AOD calculated by the reference node, or the like may be used.

S504: The location service node sends positioning assistance information to the to-be-positioned node.

The location service node may send positioning assistance data to the to-be-positioned node by using an LTE Positioning Protocol (LPP).

For example, the positioning assistance information sent by the location service node to the to-be-positioned node may include configuration information of a downlink positioning measurement reference signal and configuration information of an uplink positioning measurement reference signal. The downlink positioning measurement reference signal includes a PRS, a CSI-RS, a TRS, and the like. The uplink positioning measurement reference signal includes an SRS.

S505(a): The location service node sends a positioning measurement request to the reference node.

S505(b): The location service node sends a positioning measurement request to the to-be-positioned node.

It should be understood that a sequence of the positioning measurement requests sent by the location service node to the reference node and the to-be-positioned node may not be limited to the sequence shown in FIG. 5. For example, the location service node may first send the positioning measurement request to the to-be-positioned node, and then send the positioning measurement request to the reference node. Alternatively, the location server may send the positioning measurement requests to both the to-be-positioned node and the reference node. This is not limited in this disclosure.

After receiving a positioning measurement signal of the location service node, the to-be-positioned node and the reference node may measure and report positioning information (that is, the phase 2 in FIG. 5), which includes the following steps.

S506: The reference node sends a first positioning measurement reference signal to the to-be-positioned node.

The first positioning measurement reference signal includes but is not limited to a PRS, a CSI-RS, and a TRS.

In some embodiments, before sending the first positioning measurement reference signal to the to-be-positioned node, the reference node may first send indication information of a time-frequency resource to the to-be-positioned node, so that the to-be-positioned node receives the first positioning measurement reference signal on a specified time-frequency resource.

In some embodiments, when sending the first positioning measurement reference signal, the reference node records a sending moment T1 of the first positioning measurement reference signal. Optionally, the sending moment T1 corresponds to a moment at which the first positioning measurement reference signal is sent by a transmit antenna of the reference node.

It should be understood that the first positioning measurement reference signal may be transmitted to the to-be-positioned node through N transmission paths, and N is an integer greater than 1. The N transmission paths may include a first-arrival path and a strongest path. The first-arrival path is a path with a lowest signal delay, and the strongest path is a path with smallest signal attenuation, that is, a path with a highest signal strength.

In some embodiments, the first-arrival path and the strongest path are a same transmission path. In some other embodiments, due to impact of an obstacle or the like, the first-arrival path and the strongest path are two different transmission paths.

S507: The to-be-positioned node calculates first positioning information on a first transmission path.

The first transmission path is one of the N transmission paths, for example, the first-arrival path and/or the strongest path.

In some embodiments, the to-be-positioned node receives the first positioning measurement reference signal on the specified time-frequency domain resource based on the indication information that is of the time-frequency domain resource and that is sent by the reference node.

In some embodiments, the to-be-positioned node may calculate a received power of the first positioning measurement reference signal, to obtain strengths of the first positioning measurement reference signal on different transmission paths.

In some embodiments, the to-be-positioned node may select the first transmission path according to a specific criterion to calculate the positioning information. To ensure accuracy of positioning information, the first transmission path in this embodiment of this disclosure may be the first-arrival path or the strongest path, or may be both the first-arrival path and the strongest path. For example, when the to-be-positioned node has a strong antenna capability and a strong calculation capability, and can identify a plurality of paths, the to-be-positioned node may determine, based on an arrival moment of the first positioning measurement reference signal on each transmission path, that a transmission path corresponding to the first positioning measurement reference signal that first arrives is the first-arrival path. The to-be-positioned node may also determine, based on the strength of the received first positioning measurement reference signal, that a transmission path with a highest signal power is the strongest path. Then, the to-be-positioned node selects the first-arrival path or the strongest path according to a specific determining criterion to calculate the positioning information.

For example, the determining criterion for the to-be-positioned node to select the first-arrival path and the strongest path is as follows. The to-be-positioned node determines a delay error and a signal strength error between the first-arrival path and the strongest path, and selects, based on the delay error and the signal strength error, a path that has little impact on positioning precision to calculate the positioning information. For example, because the distance measurement information of the first-arrival path is more accurate, an arrival moment of the positioning measurement reference signal on the first-arrival path may be used as a reference to determine a deviation of an arrival moment of the strongest path, thereby reflecting a deviation of the distance measurement information. The angle information of the strongest path is more accurate, and therefore, a power of the positioning measurement reference signal on the strongest path may be used as a reference to determine an error of the signal strength on the first-arrival path, thereby reflecting an error of the angle information. According to the foregoing criterion, when the to-be-positioned node determines that the angle error is greater than the distance measurement error, if the first-arrival path is selected to calculate the positioning information, the angle error is excessively large, and a positioning information error is large. Therefore, the strongest path may be selected to calculate the positioning information. When the to-be-positioned node determines that the distance measurement information error is greater than the angle error, if the strongest path is selected to calculate the positioning information, the deviation of the distance measurement information is excessively large. In this case, the first-arrival path may be selected to calculate the positioning information.

In some embodiments, the to-be-positioned node may record an arrival moment T2 of the first positioning measurement reference signal on the first transmission path. Optionally, the arrival moment T2 may be a moment at which the first positioning measurement reference signal arrives at a receive antenna of the to-be-positioned node.

In some embodiments, the to-be-positioned node may calculate an angle of arrival AOA1 of the first transmission path according to a super-resolution algorithm or a multi-signal classification algorithm.

S508: The to-be-positioned node sends the first indication information to the reference node.

The first indication information is used to indicate information about the first transmission path. Alternatively, the first indication information is used to indicate first intermediate information used when the first positioning information is obtained. The first intermediate information may include a DFT base vector corresponding to the first transmission path in a precoding submatrix.

It should be understood that the first intermediate information herein may further include other information used to measure the first positioning information, and the first intermediate information has an association relationship with the first transmission path, so that positioning information measured by different nodes based on the first intermediate information can correspond to a same transmission path.

In some embodiments, the first indication information may be CMPI information. The first indication information may be carried in a CSI report and reported to the reference node.

S509: The to-be-positioned node sends a second positioning measurement reference signal to the reference node.

The second positioning measurement reference signal includes but is not limited to an SRS and the like.

In some embodiments, before sending the second positioning measurement reference signal to the reference node, the to-be-positioned node may first send the indication information of the time-frequency resource to the reference node, so that the reference node receives the second positioning measurement reference signal on the specified time-frequency resource.

In some embodiments, when sending the second positioning measurement reference signal, the to-be-positioned node records a sending moment T3 of the second positioning measurement reference signal. Optionally, the sending moment T3 corresponds to a moment at which the second positioning measurement reference signal is sent by a transmit antenna of the to-be-positioned node.

It should be understood that a sequence of sending, by the to-be-positioned node, the first indication information and the second positioning measurement reference signal to the reference node shown in FIG. 5 is merely an example. In other words, the steps S508 and S509 shown in the figure are not unique implementations. In actual application, a plurality of implementations may be further included. For example, the to-be-positioned node first sends the second positioning measurement reference signal to the reference node on the specified time-frequency resource, and then sends the first indication information. Alternatively, the to-be-positioned node simultaneously sends the first indication information and the second positioning measurement reference signal to the reference node. This is not limited in this disclosure.

S510: The reference node calculates second positioning information on the first transmission path based on the first indication information.

The second positioning information includes but is not limited to an arrival moment T4 of the second positioning measurement reference signal, an AOA2 of the first transmission path, and the like.

In some embodiments, when obtaining, based on the first indication information, a transmission path corresponding to the first positioning information calculated by the to-be-positioned node, that is, the first transmission path, the reference node calculates the arrival moment T4 of the second positioning measurement reference signal on the first transmission path, the AOA2 corresponding to the first transmission path, and the like. Alternatively, when obtaining, based on the first indication information, the DFT base vector in the precoding submatrix that is used by the to-be-positioned node to calculate the first positioning information, the reference node calculates the second positioning information based on the DFT base vector in a same precoding submatrix, and also obtains the positioning information corresponding to the first transmission path.

S511: The to-be-positioned node sends third positioning information to the location service node.

The third positioning information includes positioning information calculated by the to-be-positioned node based on the first transmission path, and includes but is not limited to: T2 and T3, T3−T2, T2, T3, and AOA1/AOD1, T3−T2, and AOA1/AOD1, or the like.

In some embodiments, the to-be-positioned node may report the third positioning information to the location service node by using an LPP message. Optionally, the message may further include a CSI-RSPS.

It should be understood that the step S511 may alternatively be performed after the step S507. For example, after obtaining the first positioning information based on the first transmission path, the to-be-positioned node may obtain the third positioning information based on the first positioning information, and report the third positioning information to the location service node. A sending time of the third positioning information is not limited in this disclosure.

S512: The reference node sends fourth positioning information to the location service node.

The fourth positioning information includes positioning information calculated by the reference node based on the first transmission path, and includes but is not limited to: T1 and T4, T4−T1, T1, T4, AOA2 and/or AOD2, T4−T1, AOA2 and/or AOD2, or the like.

In some embodiments, the reference node may report the fourth positioning information to the location service node by using an NRPPa message. Optionally, the message may further include an SRS-RSPS.

In some embodiments, after receiving the third positioning information and the fourth positioning information, the location service node may determine the positioning information of the to-be-positioned node based on the measurement values T3−T2 (or T2, T3), AOAL and/or AOD1 that are/is reported by the to-be-positioned node, and the measurement values T4−T1 (or T1, T4), AOA2, and/or AOD2 that are/is reported by the reference node. Alternatively, the location service node may complete AOD2 and AOA2 measurement based on the reported RSRP of the downlink positioning measurement reference signal and the reported RSRP of the uplink positioning measurement reference signal, and complete single-anchor hybrid positioning.

Further, the location service node may calculate time information based on an RTT method in the 3GPP R16 standard, that is, RTT=−(R3−R2)+(T4−T1). Angle information may be determined based on the measured angle information AOA2/AOD2 sent by the reference node, or may be determined based on the measured angle information AOA1/AOD1 sent by the to-be-positioned node.

Optionally, when antenna capabilities of both the reference node and the to-be-positioned node are strong enough, both the reference node and the to-be-positioned node can perform accurate angle measurement. In this case, to further improve positioning precision, a weighted value (for example, an average value) of the AOA1 and the AOD1, or a weighted value (for example, an average value) of the AOD2 and the AOA2 may be used as optimized angle information, to complete hybrid positioning.

In some possible implementations, the location service node determines an RTT based on first time information and second time information. Then, the location service node calculates the positioning information of the to-be-positioned node based on the round trip time, the AOA1 in the first angle information, and the AOD2 in the second angle information. Alternatively, the location service node calculates the positioning information of the to-be-positioned node based on the round trip time, the AOA1 in the first angle information, and the AOA2 in the second angle information. Alternatively, the location service node calculates the positioning information of the to-be-positioned node based on the round trip time, a weighted value of the AOA1 and the AOD1 in the first angle information, and the AOA2 in the second angle information. Alternatively, the location service node calculates the positioning information of the to-be-positioned node based on the round trip time, the weighted value of the AOA1 and the AOD1 in the first angle information, and the AOD2 in the second angle information. Alternatively, the location service node calculates the positioning information of the to-be-positioned node based on the round trip time, the weighted value of the AOA1 and the AOD1 in the first angle information, and a weighted value of the AOA2 and the AOD2 in the second angle information. Alternatively, the location service node calculates the positioning information of the to-be-positioned node based on the round trip time, the AOA1 in the first angle information, and the weighted value of the AOA2 and the AOD2 in the second angle information. Alternatively, the location service node calculates the positioning information of the to-be-positioned node based on the round trip time, the AOD1 in the first angle information, and the weighted value of the AOA2 and the AOD2 in the second angle information.

For a specific hybrid positioning process in which the location service node determines the location information of the to-be-positioned node based on the reported measurement information, refer to an existing procedure. Details are not described herein again.

According to the multipath single-anchor positioning method provided in this embodiment of this disclosure, indication information of a transmission path corresponding to positioning information measured by a to-be-positioned node or indication information of a DFT base vector in a precoding submatrix used for measuring the positioning information is sent to a reference node, so that the reference node can measure positioning information based on a same transmission path or based on a same DFT base vector. This ensures that the positioning information measured by the reference node and the to-be-positioned node is positioning information on a same transmission path, or positioning information on a transmission path under projection of a same DFT base vector, and improves accuracy of the positioning information and positioning precision.

It should be understood that, in addition to sending first indication information to the reference node, the to-be-positioned node further needs to send the following information to the reference node: (1) a PMI, where the to-be-positioned node estimates a channel matrix based on a real-time channel change status, and selects, from a codebook according to a specific criterion, a precoding matrix that best matches a downlink channel, to determine the PMI, (2) a CQI, where the to-be-positioned node may further determine, based on the determined PMI, channel quality obtained after the PMI is used, that is, the CQI, and the CQI is also fed, as CSI, back to a network device, for example, the location service node, and (3) an RI of a channel matrix, where the RI is a quantity of layers of data that can be carried by a physical channel.

For ease of understanding, with reference to the accompanying drawings, the following describes specific content of the first indication information and a structure of the CSI in two scenarios in which the to-be-positioned node can identify a plurality of paths (a case 1) and cannot identify the plurality of paths (a case 2).

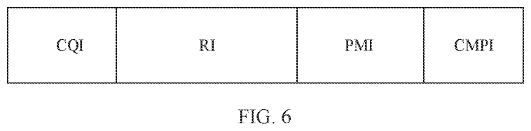

For example, FIG. 6 is a schematic diagram of a structure of channel state information according to an embodiment of this disclosure.

For the case 1, it should be understood that when the to-be-positioned node has a strong antenna capability (for example, a quantity of antennas is greater than or equal to 3) or a strong processing capability (for example, a calculation capability), the to-be-positioned node has a strong multipath identification capability, can identify each of the N transmission paths, and can calculate positioning information like a time of arrival and an angle of each transmission path. In this case, the to-be-positioned node may identify the first transmission path (for example, the first-arrival path and the strongest path), and calculate the positioning information based on the first transmission path. Then, the to-be-positioned node may send the indication information of the first transmission path to the reference node, so that the reference node also calculates the positioning information based on the first transmission path.

Further, the indication information of the first transmission path may be CMPI information, and is carried in channel state indicator CSI information (as shown in FIG. 6). For example, the CSI shown in FIG. 6 includes a CQI, an RI, a PMI, and a CMPI. The CQI, the RI, and the PMI may be existing content in an existing standard, for example, the same as content in NR standard release 15 (Rel-15) and NR standard release 16 (Rel-16), and details are not described herein again. The CMPI is a field newly added to the CSI, and aims to indicate information about the first transmission path, so that the reference node learns a transmission path corresponding to the positioning information calculated by the to-be-positioned node, and calculates the positioning information by using a same transmission path, for example, TOA2 measurement and AOA2 measurement.

In some embodiments, the CMPI may be represented by 1-bit information. For example, when the first transmission path is the first-arrival path, the CMPI is represented by “0”, which indicates that the to-be-positioned node measures the positioning information by using the first-arrival path. When the first transmission path is the strongest path, the CMPI is represented by “1”, which indicates that the to-be-positioned node measures the positioning information by using the strongest path. Alternatively, when the first transmission path is the first-arrival path, the CMPI is represented by “1”, which indicates that the to-be-positioned node measures the positioning information by using the first-arrival path. When the first transmission path is the strongest path, the CMPI is represented by “0”, which indicates that the to-be-positioned node measures the positioning information by using the strongest path.

In some embodiments, after receiving the CSI report, the reference node may parse the CMPI to learn of a transmission path indicated by the CMPI, and then complete positioning information measurement, for example, T4 and AOA2/AOD2, T4−T1 and AOA2/AOD2, or the like, based on the path indicated by the CMPI.

According to the foregoing multipath single-anchor positioning method, the to-be-positioned node indicates, to the reference node, a transmission path selected when the to-be-positioned node measures the positioning information, so that the reference node can measure the positioning information based on a same transmission path. This can ensure that both the to-be-positioned node and the reference node complete positioning information measurement based on the same transmission path, and an RTT, angle information, and the like correspond to the same transmission path, to reduce multipath interference and obtain more accurate positioning precision.

For the case 2, it should be understood that when the to-be-positioned node has a weak antenna capability of (for example, a quantity of antennas is less than 3) or a weak processing capability (for example, a calculation capability), the to-be-positioned node is unable to identify each of the N transmission paths. In this case, the to-be-positioned node may indicate, to the reference node, a DFT base vector in the precoding submatrix used for measuring the positioning information. The reference node completes positioning information measurement by using a same DFT base vector in a same precoding submatrix and based on the received PMI and DFT base vector indication information. This ensures that the positioning information measured by the to-be-positioned node and the reference node corresponds to a same transmission path, avoids impact caused by a plurality of paths, and improves measurement precision of the positioning information.

To better understand the multipath single-anchor positioning method provided in this embodiment of this disclosure, the to-be-positioned node and the reference node measure the positioning information based on the same DFT base vector. This can reduce a probability of multipath interference, to improve positioning precision. The following describes a related process.

In some embodiments, after receiving the first positioning measurement reference signal on the N transmission paths, the to-be-positioned node may project the first positioning measurement reference signal to delay domain, or delay domain and angle domain by using the DFT base vector. For example, the to-be-positioned node performs frequency domain DFT base vector projection on the first positioning measurement reference signals on the N transmission paths, to project the first positioning measurement reference signals to the delay domain, or performs frequency domain DFT base vector projection and spatial domain DFT base vector projection on the first positioning measurement reference signals, to project the first positioning measurement reference signals to the delay domain and the angle domain. Then, the to-be-positioned node may determine the first-arrival path based on the delay domain, or determine the first-arrival path and the strongest path based on the angle domain and the delay domain, and then select the first-arrival path or the strongest path to measure the positioning information.

It should be understood that, after DFT base vector projection is performed on the first positioning measurement reference signal, there is an association relationship between the transmission path and the DFT base vector in the precoding submatrix. For example, after the frequency domain DFT base vector projection is performed on the first positioning measurement reference signal, different transmission paths exhibit different delay characteristics on different frequency domain DFT base vectors. Alternatively, after the spatial domain DFT base vector projection and the frequency domain DFT base vector projection are separately performed on the first positioning measurement reference signal, different transmission paths exhibit different delay characteristics and angle characteristics on different frequency domain DFT base vectors and different spatial domain DFT base vectors.

Based on the foregoing analysis, it is assumed that when the first transmission path is projected to the delay domain or to the delay domain and the angle domain, a corresponding projection vector is a DFT base vector in a first precoding submatrix, and the to-be-positioned node selects the DFT base vector to calculate the positioning information, the positioning information measured by the to-be-positioned node is positioning information on the first transmission path. Therefore, if the to-be-positioned node sends, to the reference node, indication information of the DFT base vector in the precoding submatrix used for calculating the positioning information, so that the reference node also calculates the positioning information based on a same DFT base vector/beam, it can be ensured that the positioning information measured by the reference node is positioning information corresponding to the first transmission path, that is a transmission path under projection of the same DFT base vector. This ensures that the positioning information calculated by the to-be-positioned node and the reference node corresponds to a same transmission path, and can prevent the positioning information from being affected by multipath interference.

In some embodiments, to enable the to-be-positioned node and the reference node to complete multipath identification calculation by using a DFT base vector in a same precoding submatrix, the reference node uses a same antenna configuration when sending the downlink measurement reference signal and receiving the uplink measurement reference signal, and the downlink positioning measurement reference signal and the uplink positioning measurement reference signal need to have a same bandwidth. This ensures that the precoding submatrix and the DFT base vector that are reported by the to-be-positioned node have a same dimension as the precoding submatrix and the DFT base vector that are used by the reference node, and further ensures that the reference node and the to-be-positioned node complete positioning information measurement on a same transmission path.

In actual application, a specific implementation procedure may include the following steps. When the downlink positioning measurement reference signal (herein, a CSI-RS is used as an example) is sent, CSI-RS outer weight weighting may be first performed on the reference signal. It is assumed that a CSI-RS signal supports P-port and Q-layer (or stream) sending, a quantity of antennas of the reference node is N_{BS} (N_{BS} is an integer greater than or equal to 3), and a matrix size of an outer weight Wₒᵤₜ^{BS} is N_{BS}×P. In this case, a dimension of the sent CSI-RS is N_{BS}×Q. After a signal is transmitted through a channel H_{M}_{_{UE}}_{×N}_{_{BS}} (M_{UE} is a quantity of antennas of the to-be-positioned node), the to-be-positioned node receives a received signal whose dimension is M_{UE}×Q, and obtains a P×Q signal after weighting solution is performed on the outer weight by using a post-coding matrix whose dimension is P×M_{UE}. Then, the to-be-positioned node performs DFT vector projection on the signal obtained after weighting solution is performed on the outer weight, to identify many paths, and each path corresponds to one DFT base vector in one precoding submatrix. It should be understood that the outer weight herein is a static matrix (or static weight) fixed on the reference node side. When another weight is not applicable (for example, channel correction fails, or no CSI measurement information is reported when a user just accesses a network), weighting may be performed by using the outer weight. Each group of outer weights corresponds to a group of beams.

Then, the to-be-positioned node measures information like T2 and AOA1 on one of the paths. After completing positioning information measurement, the to-be-positioned node adds CMPI information in the CSI report, to notify the reference node that the to-be-positioned node measures the positioning information by using which specific DFT base vector in which precoding submatrix. Then, the to-be-positioned node may send the uplink positioning measurement reference signal, for example, an SRS, to the reference node.

The reference node separately obtains the CSI report and the uplink positioning measurement reference signal SRS on the specified time-frequency resource. An SRS signal obtained after layer mapping is performed on the to-be-positioned node side has a dimension of P×Q, a matrix of the outer weight Wₒᵤₜ^{UE} has a size of N_{UE}×P, and a quantity of transmit antennas of UE is N_{UE}. After a signal is transmitted through a channel H_{M}_{_{BS}}_{×N}_{_{UE}} (M_{BS} is a quantity of antennas of the reference node), the reference node receives a received signal whose dimension is M_{BS}×Q, and obtains the P×Q signal after weighting solution is performed on the outer weight by using a post-coding matrix whose dimension is P×M_{BS}. Then, the reference node performs DFT vector projection on the signal obtained after weighting solution is performed on the outer weight, and complete measurement of positioning information like T4 and AOA2 by using a DFT base vector the same as that of the to-be-positioned node based on the CMPI information in the CSI report.

In some embodiments, a method for determining a precoding matrix W by the to-be-positioned node may include the following. The to-be-positioned node determines a physical channel based on a CSI-RS pilot signal delivered by a network device (for example, the reference node), and then determines W from a predefined precoding matrix group according to a PMI detection algorithm. For a data transmission service, a principle of determining W may include but is not limited to the following. If the network device (for example, the reference node) performs weighting on data based on the precoding matrix W, a signal-to-noise ratio, a throughput, spectrum efficiency, and/or the like of data received by the to-be-positioned node are/is highest.

The precoding matrix W may be formed by a product of W₁ and W₂. W₁ is a block matrix formed by a plurality of DFT base vectors, a W₁ codebook is wideband and long-term, and meets

$${W}_{1} = \vert \begin{matrix}{X}_{1} & 0 \\ 0 & {X}_{1}\end{matrix} \vert .$$

X₁ includes K oversampled DFT base vectors/beams. The W₁ codebook is a codebook associated with a plurality of paths, and includes 2K DFT base vectors, where K is an integer greater than or equal to 1. The to-be-positioned node needs to notify the positioning reference node of indication information of which base vector that is in the 2K DFT base vectors and that is used by the to-be-positioned node.

The to-be-positioned node may send the PMI to the reference node to indicate the precoding matrix. The PMI includes two parts: a PMI 1 and a PMI 2. The PMI 1 is used to indicate all elements in the precoding matrix W₁, and the PMI 2 is used to indicate all elements in W₂. The indication information that is of the base vector/beam in the precoding submatrix W1 and that is carried in the CMPI described in the case 2 means information that is about which specific base vector in the K DFT base vectors in W1 associated with the multipath and that is carried in the CMPI.

It should be understood that, a principle of selecting a precoding submatrix including a DFT base vector used to measure positioning information is to minimize a delay of TOA1 and/or maximize an RSRP of the first positioning measurement reference signal, and a principle of selecting a precoding submatrix used for data precoding in data transmission is mainly to maximize a signal-to-noise ratio, a throughput, spectral efficiency, or the like. Therefore, a precoding submatrix that is used to estimate positioning information and that is selected based on different principles and based on a same reference signal and a same precoding submatrix is irrelevant to a PMI codebook or a precoding submatrix that is recommended by the to-be-positioned node to the reference node and that is used for downlink physical downlink shared channel (PDSCH) data precoding weighting. The two precoding submatrices may be the same or may be different. Therefore, the first indication information needs to be additionally sent to the reference node, to indicate which DFT base vector/beam that is in the precoding submatrix including the K DFT base vectors/beams and that is used by the to-be-positioned node to estimate the positioning information.

Different from that the first indication information is represented by one bit in the case 1, a bit size of the first indication information in the case 2 may be a submatrix size U=[log₂(K)], that is, a quantity of index bits of the K DFT base vectors/beams in a diagonal block matrix X₁ in the precoding submatrix W₁. The CPMI is used to indicate, to the reference node, which base vector/beam in the K DFT base vectors/beams is used by the to-positioned node to measure the positioning information.

According to the foregoing multipath single-anchor positioning method, a to-be-positioned node indicates, to a reference node, which DFT base vector/beam in a precoding submatrix selected by the to-be-positioned node when the to-be-positioned node measures positioning information, so that the reference node can measure positioning information based on a same DFT base vector/beam. Because the same DFT base vector corresponds to a same transmission path or a transmission path in a same beam, it can be ensured that both the to-be-positioned node and the reference node complete positioning information measurement based on the same transmission path or the transmission path in the same beam, to reduce multipath interference and obtain more accurate positioning precision.

In addition, in some other embodiments in the case 2, a codebook indicated by the PMI reported by the to-be-positioned node may be spatial domain two-dimensional (a case 3 for short below). In this case, the to-be-positioned node and the reference node measure the positioning information based on a spatial-frequency DFT two-dimensional base vector.

For example, the to-be-positioned node measures the positioning information. The to-be-positioned node may project a received CSI-RS signal to a spatial domain DFT base vector and a frequency domain DFT base vector (equivalent to transforming the signal into angle domain and delay domain). In this case, each path corresponds to one spatial-frequency two-dimensional DFT base vector. Therefore, in the CSI report reported by the to-be-positioned node to the reference node, the to-be-positioned node needs to indicate, to the reference node, a spatial-frequency two-dimensional DFT base vector used by the to-be-positioned node to measure the positioning information, to ensure that the reference node and the to-be-positioned node calculate the third positioning information by using a same spatial-frequency two-dimensional DFT base vector.

In the case 3, the precoding submatrix indicated by the PMI reported by the to-be-positioned node is spatial-frequency two-dimensional, similar to the spatial-frequency precoding submatrix in 3GPP release 16 (R16). In this case, the CMPI indicates that the to-be-positioned node measures the first positioning information by using a spatial-frequency DFT base vector pair corresponding to which <angle, delay> pair.

A spatial-frequency two-dimensional codebook of 3GPP R16 is used as an example. The precoding matrix may be represented as W=W₁ [symbol] W_{f}^{H}, where W₁ represents spatial domain compression, W_{f}^{H} represents frequency domain compression, and [symbol] represents a linear combination coefficient. In this case, W₁ may include a submatrix including a spatial domain DFT base vector, and W_{f}^{H} may include a submatrix including a frequency domain DFT base vector. Therefore, the CMPI indication information needs to include an indication bit used to indicate which spatial domain DFT base vector in W₁ is selected and which frequency domain DFT base vector in W_{f}^{H} is selected. For example, a size of the indication bit is S=[log₂(U)+log₂(V)], where U and V are dimensions/index values of the spatial domain DFT base vector and the frequency domain DFT base vector, respectively, and log₂(U) and log₂(V) are quantities of index bits of the spatial domain DFT base vector and the frequency domain DFT base vector, respectively. The CMPI is used to indicate, to the reference node, which spatial domain DFT base vector/beam and which frequency domain DFT base vector/beam are used by the to-be-positioned node to measure the first positioning information.

According to the foregoing multipath single-anchor positioning method, a to-be-positioned node indicates, to a reference node, a DFT base vector selected by the to-be-positioned node when the to-be-positioned node measures positioning information, so that the reference node can measure positioning information based on a same DFT base vector. Because the same DFT base vector corresponds to a same transmission path or a transmission path in a same beam, it can be ensured that both the to-be-positioned node and the reference node complete positioning information measurement based on the same transmission path or the transmission path in the same beam, to reduce multipath interference and obtain more accurate positioning precision.

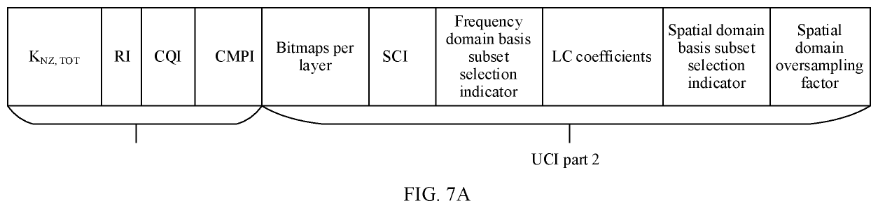

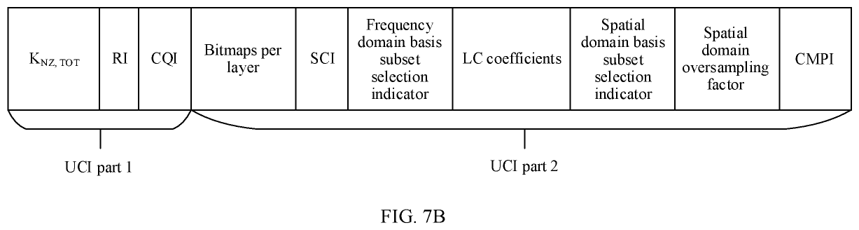

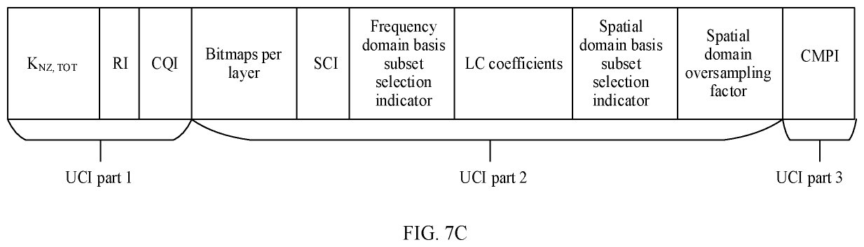

For example, there may be a plurality of locations of the first indication information in the CSI report. This is not limited in this disclosure. FIG. 7A, FIG. 7B, and FIG. 7C are schematic diagrams of a structure of different locations of the first indication information in the CSI report by using an example in which the first indication information is a CPMI (specific content may include the content described in the foregoing three cases).

In some embodiments, as shown in FIG. 7A, in a manner of carrying the CMPI in the CSI report, a bit may be added to a uplink control information (UCI) (Uplink) part 1 in the CSI report to carry the indication information.

Alternatively, as shown in FIG. 7B, in a manner of carrying the CMPI in the CSI report, a bit may be added to a UCI part 2 in the CSI report to carry the CMPI indication information.

Alternatively, as shown in FIG. 7C, the CMPI may be separately placed as a newly added UCI part 3 in the CSI report.

In addition to the foregoing CQI, RI, and CMPI, the CSI in the UCI part 1 in FIG. 7A, FIG. 7B, and FIG. 7C further includes K_{NZ,TOT}, used to indicate a quantity of all bitmaps per layer, and the bitmaps per layer correspond to a bitmap per layer, a strongest coefficient indicator (SCI), a frequency domain (FD) basis subset selection indicator, an spatial domain (SD) basis subset selection indicator, and a SD oversampling factor.

For example, FIG. 8 is a schematic diagram of a structure of a communication node according to an embodiment of this disclosure. A communication node 800 includes a receiving module 801, a processing module 802, and a sending module 803.

In an implementation, the receiving module 801 may be configured to receive a first positioning measurement reference signal transmitted through N transmission paths. The first positioning measurement reference signal is sent by a reference node, and N is an integer greater than 1.

In an implementation, the processing module 802 may be configured to measure first positioning information based on the first positioning measurement reference signal on a first transmission path. The first transmission path is one of the N transmission paths.

In an implementation, the sending module 803 may be configured to send first indication information and a second positioning measurement reference signal to a reference node. The first indication information is used to indicate the first transmission path, so that the reference node measures second positioning information on the first transmission path

In an implementation, the first transmission path is a first-arrival path or a strongest path. The first positioning measurement reference signal has a lowest transmission delay on the first-arrival path, and the first positioning measurement reference signal has smallest attenuation on the strongest path. The processing module 802 may be further configured to determine the first transmission path based on a transmission delay and/or a signal power of the first positioning measurement reference signal.

In an implementation, the processing module 802 may be configured to measure the first positioning information based on the first positioning measurement reference signal on the first transmission path, including recording an arrival moment T2 of the first positioning measurement reference signal, and measuring an angle of arrival AOA1 of the first positioning measurement reference signal.

In an implementation, the processing module 802 may be further configured to record a sending moment T3 of the second positioning measurement reference signal, and/or measure an angle of departure AOD1 of the second positioning measurement reference signal.

In an implementation, the sending module 803 may be further configured to send third positioning information to a location service node. The third positioning information includes first time information. Alternatively, the third positioning information includes first time information and first angle information. The first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal. The first angle information includes the angle of arrival AOA1 of the first positioning measurement reference signal, and/or the angle of departure AOD1 of the second positioning measurement reference signal.

Alternatively, in an implementation, the receiving module 801 may be configured to receive a first positioning measurement reference signal transmitted through N transmission paths. The first positioning measurement reference signal is sent by a reference node, and N is an integer greater than 1.

The processing module 802 may be configured to measure first positioning information based on first intermediate information. The first intermediate information includes a DFT base vector corresponding to a first transmission path in a precoding matrix, and the first transmission path is one of the N transmission paths.

The sending module 803 may be configured to send first indication information and a second positioning measurement reference signal to a reference node. The first indication information is used to indicate the first intermediate information, so that the reference node measures second positioning information based on the first intermediate information.

In an implementation, that the first indication information is used to indicate the first intermediate information includes the following. The first indication information includes identification information of the DFT base vector.

In an implementation, that the first indication information is used to indicate the first intermediate information includes the following. The first indication information includes index information of the DFT base vector in the precoding submatrix.

In an implementation, the DFT base vector is a frequency domain DFT base vector. Alternatively, the DFT base vector is a spatial domain and frequency domain two-dimensional base vector.

In an implementation, the first transmission path is a first-arrival path or a strongest path. The first positioning measurement reference signal has a lowest transmission delay on the first-arrival path, and the first positioning measurement reference signal has smallest attenuation on the strongest path. The processing module 802 may be further configured to determine the first transmission path based on a transmission delay and/or a signal power of the first positioning measurement reference signal.

In an implementation, the processing module 802 may be further configured to record a first arrival moment T2 of the first positioning measurement reference signal, and measure a first angle of arrival AOA1 of the first positioning measurement reference signal.

In an implementation, the processing module 802 may be further configured to record a first sending moment T3 of the second positioning measurement reference signal, and/or measure a first angle of departure AOD1 of the second positioning measurement reference signal.

In an implementation, the sending module 803 may be further configured to send third positioning information to a location service node. The third positioning information includes first time information. Alternatively, the third positioning information includes first time information and first angle information. The first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal. The first angle information includes the angle of arrival AOA1 of the first positioning measurement reference signal, and/or the angle of departure AOD1 of the second positioning measurement reference signal.

In an implementation, the first indication information is carried in channel state information.

In an implementation, the channel state information further includes but is not limited to: PMI information, CQI information, and RI information of a channel matrix.

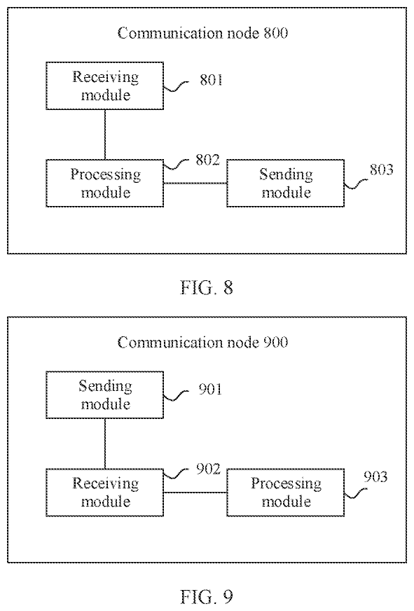

For example, FIG. 9 is a schematic diagram of a structure of a communication node according to an embodiment of this disclosure. A communication node 900 may be a reference node. The communication node 900 includes a sending module 901, a receiving module 902, and a processing module 903.

In an implementation, the sending module 901 may be configured to send a first positioning measurement reference signal. The first positioning measurement reference signal is transmitted to a to-be-positioned node through N transmission paths, and N is an integer greater than 1.

The receiving module 902 may be configured to receive first indication information and a second positioning measurement reference signal that are sent by the to-be-positioned node. The first indication information is used to indicate a first transmission path, and the first transmission path is one of the N transmission paths.

The processing module 903 may be configured to measure second positioning information based on the first transmission path.

In an implementation, the first transmission path is a first-arrival path or a strongest path. The first positioning measurement reference signal has a lowest transmission delay on the first-arrival path, and the first positioning measurement reference signal has smallest attenuation on the strongest path.

In an implementation, that the first indication information is represented by 1-bit information, and the first indication information is used to indicate information about the first transmission path includes the following. When the first transmission path is the first-arrival path, the first indication information is 1. When the first transmission path is the strongest path, the first indication information is 0. Alternatively, when the first transmission path is the first-arrival path, the first indication information is 0. When the first transmission path is the strongest path, the first indication information is 1.

In an implementation, the processing module 903 may be further configured to record an arrival moment T4 of the second positioning measurement reference signal, and measure an angle of arrival AOA2 of the second positioning measurement reference signal.

In an implementation, the processing module 903 may be further configured to record a sending moment T1 of the first positioning measurement reference signal, and/or measure an angle of departure AOD2 of the first positioning measurement reference signal.

In an implementation, the sending module 901 may be further configured to send fourth positioning information to a location service node. The fourth positioning information includes second time information. Alternatively, the fourth positioning information includes second time information and second angle information. The second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal. The first angle information includes an angle of departure AOA2 of the first positioning measurement reference signal, and/or an angle of arrival AOD2 of the second positioning measurement reference signal.

In an implementation, the first indication information is carried in channel state information.

In an implementation, the channel state information further includes but is not limited to: PMI information, CQI information, and RI information of a channel matrix.

Alternatively, in an implementation, the sending module 901 may be configured to send a first positioning measurement reference signal. The first positioning measurement reference signal is transmitted to a to-be-positioned node through N transmission paths, and N is an integer greater than 1.

The receiving module 902 may be configured to receive first indication information and a second positioning measurement reference signal that are sent by the to-be-positioned node. The first indication information is used to indicate first intermediate information, the first intermediate information is a DFT base vector corresponding to a first transmission path, and the first transmission path is one of the N transmission paths.

The processing module 903 may be configured to measure second positioning information based on the first measurement information.

In an implementation, that the first indication information is used to indicate the first intermediate information includes the following. The first indication information includes identification information of the DFT base vector/beam.

In an implementation, that the first indication information is used to indicate the first intermediate information includes the following. The first indication information includes index information of a DFT base vector in a precoding submatrix.

In an implementation, the DFT base vector is a domain DFT base vector. Alternatively, the DFT base vector is a spatial-frequency two-dimensional base vector.

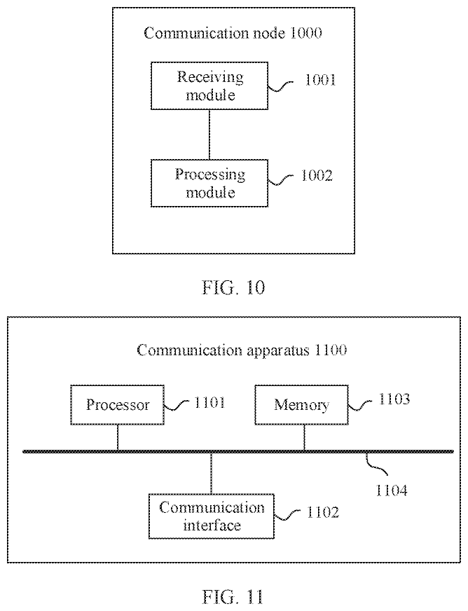

For example, FIG. 10 is a schematic diagram of a structure of still another communication node. A communication node 1000 includes a receiving module 1001 and a processing module 1002.

In an implementation, the receiving module 1001 may be configured to receive third positioning information sent by a to-be-positioned node and fourth positioning information sent by a reference node. The third positioning information and the fourth positioning information respectively include positioning information obtained by the to-be-positioned node based on a first transmission path and positioning information obtained by the reference node based on the first transmission path. Alternatively, the third positioning information and the fourth positioning information respectively include positioning information obtained by the to-be-positioned node based on same first intermediate information and positioning information obtained by the reference node based on the same first intermediate information. The first intermediate information includes a DFT base vector

In an implementation, the processing module 1002 may be configured to position the to-be-positioned node based on the third positioning information and the fourth positioning information.

In an implementation, the processing module 1002 may be further configured to determine a round trip time based on the first time information and the second time information, calculate the positioning information of the to-be-positioned node based on the round trip time, the AOA1 in the first angle information, and the AOD2 in the second angle information, calculate the positioning information of the to-be-positioned node based on the round trip time, the AOD1 in the first angle information, and the AOA2 in the second angle information, calculate the positioning information of the to-be-positioned node based on the round trip time, a weighted value of the AOA1 and the AOD1 in the first angle information, and the AOA2 in the second angle information, calculate the positioning information of the to-be-positioned node based on the round trip time, the weighted value of the AOA1 and the AOD1 in the first angle information, and the AOD2 in the second angle information, calculate the positioning information of the to-be-positioned node based on the round trip time, the weighted value of the AOA1 and the AOD1 in the first angle information, and a weighted value of the AOA2 and the AOD2 in the second angle information, calculate the positioning information of the to-be-positioned node based on the round trip time, the AOA1 in the first angle information, and the weighted value of the AOA2 and the AOD2 in the second angle information, or calculate the positioning information of the to-be-positioned node based on the round trip time, the AOD1 in the first angle information, and the weighted value of the AOA2 and AOD2 in the second angle information.

FIG. 11 is a schematic diagram of a structure of a communication apparatus according to an embodiment of this disclosure. A communication apparatus 1100 includes at least one processor 1101, a communication interface 1102, and a memory 1103. The communication interface is used for information exchange between the communication apparatus and another communication apparatus. The memory stores computer program instructions. When the program instructions are executed by the at least one processor, the communication apparatus is enabled to implement a function of the positioning manner triggering method described above on any one of the following nodes: the source node or the target node.

The processor 1101, the communication interface 1102, and the memory 1103 are connected to each other through a bus 1104. The bus 1104 may be a Peripheral Component Interconnect (PCI) bus, an Extended Industry Standard Architecture (EISA) bus, or the like. The bus 1104 may be classified into an address bus, a data bus, a control bus, and the like. For ease of representation, only one bold line is used to represent the bus in FIG. 11, but this does not mean that there is only one bus or only one type of bus.

This embodiment of this disclosure further provides a non-volatile storage medium. The non-volatile storage medium stores one or more pieces of program code. When the processor 1101 of the communication apparatus 1100 executes the program code, the communication apparatus 1100 is enabled to implement a function of the positioning manner triggering method described above on any one of the following nodes: the source node or the target node.

For detailed descriptions of the units or the modules in the communication apparatus 1100 provided in this embodiment of this disclosure and technical effects brought after the units perform the related method steps performed by the source node or the target node in any method embodiment of this disclosure, refer to the related descriptions in the method embodiment of this disclosure. Details are not described herein again.

With reference to the foregoing content, this disclosure further provides the following embodiments.

Embodiment 1: A multipath single-anchor positioning method, applied to a to-be-positioned node, including receiving a first positioning measurement reference signal transmitted through N transmission paths, where the first positioning measurement reference signal is sent by a reference node, and N is an integer greater than 1, measuring first positioning information based on the first positioning measurement reference signal on a first transmission path, where the first transmission path is one of the N transmission paths, and sending first indication information and a second positioning measurement reference signal to the reference node, where the first indication information is used to indicate the first transmission path, so that the reference node measures second positioning information on the first transmission path.

Embodiment 2: The method according to embodiment 1, the first transmission path is a first-arrival path or a strongest path, the first positioning measurement reference signal has a lowest transmission delay on the first-arrival path, the first positioning measurement reference signal has smallest attenuation on the strongest path, and the method further includes determining the first transmission path based on a transmission delay and/or a signal power of the first positioning measurement reference signal.

Embodiment 3: The method according to embodiment 2, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 4: The method according to any one of embodiments 1 to 3, the measuring first positioning information based on the first positioning measurement reference signal on a first transmission path includes recording an arrival moment T2 of the first positioning measurement reference signal, and measuring an angle of arrival AOA1 of the first positioning measurement reference signal.

Embodiment 5: The method according to embodiment 4, the method further includes recording a sending moment T3 of the second positioning measurement reference signal, and/or measuring an angle of departure AOD1 of the second positioning measurement reference signal.

Embodiment 6: The method according to embodiment 5, the method further includes sending third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 7: The method according to any one of embodiments 1 to 6, the first indication information is carried in channel state information.

Embodiment 8: The method according to embodiment 7, the channel state information further includes but is not limited to PMI information, CQI information, and RI information of a channel matrix.

Embodiment 9: A multipath single-anchor positioning method, applied to a reference node, including sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate a first transmission path, and the first transmission path is one of the N transmission paths, and measuring second positioning information on the first transmission path based on the first indication information.

Embodiment 10: The method according to embodiment 9, the first transmission path is a first-arrival path or a strongest path, the first positioning measurement reference signal has a lowest transmission delay on the first-arrival path, and the first positioning measurement reference signal has smallest attenuation on the strongest path.

Embodiment 11: The method according to embodiment 10, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 12: The method according to any one of embodiments 9 to 11, the measuring second positioning information on the first transmission path based on the first indication information includes recording an arrival moment T4 of the second positioning measurement reference signal, and measuring an angle of arrival AOA2 of the second positioning measurement reference signal.

Embodiment 13: The method according to embodiment 12, the method further includes recording a sending moment T1 of the first positioning measurement reference signal, and/or measuring an angle of departure AOD2 of the first positioning measurement reference signal.

Embodiment 14: The method according to embodiment 13, the method further includes sending fourth positioning information to a location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 15: The method according to any one of embodiments 9 to 14, the first indication information is carried in channel state information.

Embodiment 16: The method according to embodiment 15, the channel state information further includes but is not limited to: PMI information, CQI information, and RI information of a channel matrix.

Embodiment 17: A multipath single-anchor positioning method, applied to a to-be-positioned node, including receiving a first positioning measurement reference signal transmitted through N transmission paths, where the first positioning measurement reference signal is sent by a reference node, and N is an integer greater than 1, measuring first positioning information based on first intermediate information, where the first intermediate information includes a DFT base vector corresponding to a first transmission path in a precoding submatrix, and the first transmission path is one of the N transmission paths, and sending first indication information and a second positioning measurement reference signal to the reference node, where the first indication information is used to indicate the first intermediate information, so that the reference node measures second positioning information based on the first intermediate information indicated by the first indication information.

Embodiment 18: The method according to embodiment 17, that the first indication information is used to indicate the first intermediate information includes the first indication information includes identification information of the DFT base vector corresponding to the first transmission path in the precoding submatrix.

Embodiment 19: The method according to embodiment 18, that the first indication information includes identification information of the DFT base vector corresponding to the first transmission path in the precoding submatrix includes the first indication information includes index information of the DFT base vector.

Embodiment 20: The method according to embodiment 18 or 19, the precoding submatrix is a submatrix including a frequency domain DFT base vector, or the precoding submatrix is a submatrix including a spatial domain and frequency domain two-dimensional DFT base vector.

Embodiment 21: The method according to any one of embodiments 17 to 20, the first transmission path is a first-arrival path or a strongest path identified after projection of the DFT base vector, the first positioning measurement reference signal has a lowest transmission delay on the first-arrival path, the first positioning measurement reference signal has smallest attenuation on the strongest path, and the method further includes determining the first transmission path based on a transmission delay and/or a signal power of the first positioning measurement reference signal.

Embodiment 22: The method according to any one of embodiments 17 to 21, obtaining the first positioning information based on the first positioning measurement reference signal on the first transmission path includes recording an arrival moment T2 of the first positioning measurement reference signal, and measuring an angle of arrival AOA1 of the first positioning measurement reference signal.

Embodiment 23: The method according to embodiment 22, the method further includes recording a sending moment T3 of the second positioning measurement reference signal, and/or measuring an angle of departure AOD1 of the second positioning measurement reference signal.

Embodiment 24: The method according to embodiment 23, the method further includes sending third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 25: The method according to any one of embodiments 17 to 24, the first indication information is carried in channel state information.

Embodiment 26: The method according to embodiment 25, the channel state information further includes but is not limited to PMI information, CQI information, and RI information of a channel matrix.

Embodiment 27: A multipath single-anchor positioning method, applied to a reference node, including sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate first intermediate information, the first intermediate information includes a DFT base vector corresponding to a first transmission path in a precoding submatrix, and the first transmission path is one of the N transmission paths, and measuring second positioning information based on the first indication information by using the first intermediate information.

Embodiment 28: The method according to embodiment 27, that the first indication information is used to indicate the first intermediate information includes the first indication information includes identification information of the DFT base vector corresponding to the first transmission path in the precoding submatrix.

Embodiment 29: The method according to embodiment 27 or 28, that the first indication information is used to indicate the first intermediate information includes the first indication information includes index information of the DFT base vector.

Embodiment 30: The method according to embodiment 28 or 29, the precoding submatrix is a submatrix including a frequency domain DFT base vector, or the precoding submatrix is a submatrix including a spatial domain and frequency domain two-dimensional DFT base vector.

Embodiment 31: The method according to any one of embodiments 27 to 30, the first transmission path is a first-arrival path or a strongest path identified after projection of the DFT base vector, the first positioning measurement reference signal has a lowest transmission delay on the first-arrival path, and the first positioning measurement reference signal has smallest attenuation on the strongest path.

Embodiment 32: The method according to any one of embodiments 27 to 31, the measuring second positioning information based on the first measurement information includes recording an arrival moment T4 of the second positioning measurement reference signal, and measuring an angle of arrival AOA2 of the second positioning measurement reference signal.

Embodiment 33: The method according to embodiment 32, the method further includes recording a sending moment T1 of the first positioning measurement reference signal, and/or measuring an angle of departure AOD2 of the first positioning measurement reference signal.

Embodiment 34: The method according to embodiment 33, the method further includes sending fourth positioning information to a location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 35: The method according to any one of embodiments 27 to 34, the first indication information is carried in channel state information.

Embodiment 36: The method according to embodiment 35, the channel state information further includes but is not limited to PMI information, CQI information, and RI information of a channel matrix.

Embodiment 37: A multipath single-anchor positioning method, applied to a location service node, including receiving third positioning information sent by a to-be-positioned node and fourth positioning information sent by a reference node, where the third positioning information and the fourth positioning information respectively include positioning information obtained by the to-be-positioned node based on a first transmission path and positioning information obtained by the reference node based on the first transmission path, or the third positioning information and the fourth positioning information respectively include positioning information obtained by the to-be-positioned node based on same first intermediate information and positioning information obtained by the reference node based on the same first intermediate information, and the first intermediate information includes a DFT base vector, and positioning the to-be-positioned node based on the third positioning information and the fourth positioning information.

Embodiment 38: The method according to embodiment 37, the third positioning information includes first time information, or the third positioning information includes first time information and first angle information, where the first time information includes an arrival moment T2 of a first positioning measurement reference signal and a sending moment T3 of a second positioning measurement reference signal, or a difference T3−T2 between the sending moment T3 of the second positioning measurement reference signal and the arrival moment T2 of the first positioning measurement reference signal, where the first positioning measurement reference signal is sent by the reference node, and the second positioning measurement reference signal is sent by the to-be-positioned node, and the first angle information includes an angle of arrival AOA1 of the first positioning measurement reference signal, and/or an angle of departure AOD1 of the second positioning measurement reference signal.

Embodiment 39: The method according to embodiment 38, the fourth positioning information includes second time information, or the fourth positioning information includes second time information and second angle information, where the second time information includes an arrival moment T4 of the second positioning measurement reference signal and a sending moment T1 of the first positioning measurement reference signal, or a difference T4−T1 between the arrival moment T4 of the second positioning measurement reference signal and the sending moment T1 of the first positioning measurement reference signal, where the first positioning measurement reference signal is sent by the reference node, and the second positioning measurement reference signal is sent by the to-be-positioned node, and the second angle information includes an angle of arrival AOA2 of the second positioning measurement reference signal, and/or an angle of departure AOD2 of the first positioning measurement reference signal.

Embodiment 40: The method according to embodiment 39, the obtaining positioning information of the to-be-positioned node based on the third positioning information and the fourth positioning information includes determining a round trip time based on the first time information and the second time information, calculating the positioning information of the to-be-positioned node based on the round trip time, the AOA1 in the first angle information, and the AOD2 in the second angle information, calculating the positioning information of the to-be-positioned node based on the round trip time, the AOD1 in the first angle information, and the AOA2 in the second angle information, calculating the positioning information of the to-be-positioned node based on the round trip time, a weighted value of the AOA1 and the AOD1 in the first angle information, and the AOA2 in the second angle information, calculating the positioning information of the to-be-positioned node based on the round trip time, the weighted value of the AOA1 and the AOD1 in the first angle information, and the AOD2 in the second angle information, calculating the positioning information of the to-be-positioned node based on the round trip time, the weighted value of the AOA1 and the AOD1 in the first angle information, and a weighted value of the AOA2 and the AOD2 in the second angle information, calculating the positioning information of the to-be-positioned node based on the round trip time, the AOA1 in the first angle information, and the weighted value of the AOA2 and the AOD2 in the second angle information, or calculating the positioning information of the to-be-positioned node based on the round trip time, the AOD1 in the first angle information, and the weighted value of the AOA2 and the AOD2 in the second angle information.

Embodiment 41: A communication node, including a receiving module configured to receive a first positioning measurement reference signal transmitted through N transmission paths, where the first positioning measurement reference signal is sent by a reference node, and N is an integer greater than 1, a processing module configured to measure first positioning information based on the first positioning measurement reference signal on a first transmission path, where the first transmission path is one of the N transmission paths, and a sending module configured to send first indication information and a second positioning measurement reference signal to a reference node, where the first indication information is used to indicate the first transmission path, so that the reference node measures second positioning information on the first transmission path

Embodiment 42: The communication node according to embodiment 41, the first transmission path is a first-arrival path or a strongest path, where the first positioning measurement reference signal has a lowest transmission delay on the first-arrival path, the first positioning measurement reference signal has smallest attenuation on the strongest path, and the communication node further includes the processing module configured to determine the first transmission path based on a transmission delay and/or a signal power of the first positioning measurement reference signal.

Embodiment 43: The communication node according to embodiment 42, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 44: The communication node according to any one of embodiments 41 to 43, the processing module is further configured to record an arrival moment T2 of the first positioning measurement reference signal, and measure an angle of arrival AOA1 of the first positioning measurement reference signal.

Embodiment 45: The communication node according to embodiment 44, the processing module is further further configured to record a sending moment T3 of the second positioning measurement reference signal, and/or measure an angle of departure AOD1 of the second positioning measurement reference signal.

Embodiment 46: The communication node according to embodiment 45, the sending module is further configured to send third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 47: The communication node according to any one of embodiments 41 to 46, the first indication information is carried in channel state information.

Embodiment 48: The communication node according to embodiment 47, the channel state information further includes but is not limited to PMI information, CQI information, and RI information of a channel matrix.

Embodiment 49: A communication node, including a sending module configured to send a first positioning measurement reference signal, where the first positioning measurement reference signal is transmitted to a to-be-positioned node through N transmission paths, and N is an integer greater than 1, a receiving module configured to receive first indication information and a second positioning measurement reference signal that are sent by the to-be-positioned node, where the first indication information is used to indicate a first transmission path, and the first transmission path is one of the N transmission paths, and a processing module configured to measure second positioning information on the first transmission path based on the first indication information.

Embodiment 50: The communication node according to embodiment 49, the first transmission path is a first-arrival path or a strongest path, the first positioning measurement reference signal has a lowest transmission delay on the first-arrival path, and the first positioning measurement reference signal has smallest attenuation on the strongest path.

Embodiment 51: The communication node according to embodiment 50, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 52: The communication node according to any one of embodiments 49 to 51, the processing module is further configured to record an arrival moment T4 of the second positioning measurement reference signal, and measure an angle of arrival AOA2 of the second positioning measurement reference signal.

Embodiment 53: The communication node according to embodiment 52, the processing module is further further configured to record a sending moment T1 of the first positioning measurement reference signal, and/or measure an angle of departure AOD2 of the first positioning measurement reference signal.

Embodiment 54: The communication node according to embodiment 53, the sending module is further configured to send fourth positioning information to a location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 55: The communication node according to any one of embodiments 49 to 54, the first indication information is carried in channel state information.

Embodiment 56: The communication node according to embodiment 55, the channel state information further includes but is not limited to PMI information, CQI information, and RI information of a channel matrix.

Embodiment 57: A communication node, including a receiving module configured to receive a first positioning measurement reference signal transmitted through N transmission paths, where the first positioning measurement reference signal is sent by a reference node, and N is an integer greater than 1, a processing module configured to measure first positioning information based on first intermediate information, where the first intermediate information includes a DFT base vector corresponding to a first transmission path in a precoding submatrix, and the first transmission path is one of the N transmission paths, and a sending module configured to send first indication information and a second positioning measurement reference signal to a reference node, where the first indication information is used to indicate the first intermediate information, so that the reference node measures second positioning information based on the first intermediate information indicated by the first indication information.

Embodiment 58: The communication node according to embodiment 57, that the first indication information is used to indicate the first intermediate information includes the first indication information includes identification information of the DFT base vector corresponding to the first transmission path in the precoding submatrix.

Embodiment 59: The communication node according to embodiment 58, that the first indication information includes identification information of the DFT base vector corresponding to the first transmission path in the precoding submatrix includes the first indication information includes index information of the DFT base vector.

Embodiment 60: The communication node according to embodiment 58 or 59, the precoding submatrix is a submatrix including a frequency domain DFT base vector, or the precoding submatrix is a submatrix including a spatial domain and frequency domain two-dimensional DFT base vector.

Embodiment 61: The communication node according to any one of embodiments 57 to 60, the first transmission path is a first-arrival path or a strongest path identified after projection of the DFT base vector, the first positioning measurement reference signal has a lowest transmission delay on the first-arrival path, the first positioning measurement reference signal has smallest attenuation on the strongest path, and the processing module is further configured to determine the first transmission path based on a transmission delay and/or signal power of the first positioning measurement reference signal.

Embodiment 62: The communication node according to any one of embodiments 57 to 61, the processing module is further configured to record an arrival moment T2 of the first positioning measurement reference signal, and measure an angle of arrival AOA1 of the first positioning measurement reference signal.

Embodiment 63: The communication node according to embodiment 62, the processing module is further further configured to record a sending moment T3 of the second positioning measurement reference signal, and/or measure an angle of departure AOD1 of the second positioning measurement reference signal.

Embodiment 64: The communication node according to embodiment 63, the sending module is further configured to send third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 65: The communication node according to any one of embodiments 57 to 64, the first indication information is carried in channel state information.

Embodiment 66: The communication node according to embodiment 65, the channel state information further includes but is not limited to PMI information, CQI information, and RI information of a channel matrix.

Embodiment 67: A communication node, including a sending module configured to send a first positioning measurement reference signal, where the first positioning measurement reference signal is transmitted to a to-be-positioned node through N transmission paths, and N is an integer greater than 1, a receiving module configured to receive first indication information and a second positioning measurement reference signal that are sent by the to-be-positioned node, where the first indication information is used to indicate first intermediate information, the first intermediate information includes a DFT base vector corresponding to a first transmission path in a precoding submatrix, and the first transmission path is one of the N transmission paths, and a processing module configured to measure second positioning information based on the first indication information by using the first intermediate information.

Embodiment 68: The communication node according to embodiment 67, that the first indication information is used to indicate the first intermediate information includes the first indication information includes identification information of the DFT base vector corresponding to the first transmission path in the precoding submatrix.

Embodiment 69: The communication node according to embodiment 67 or 68, that the first indication information is used to indicate the first intermediate information includes the first indication information includes index information of the DFT base vector.

Embodiment 70: The communication node according to embodiment 68 or 69, the precoding submatrix is a submatrix including a frequency domain DFT base vector, or the precoding submatrix is a submatrix including a spatial domain and frequency domain two-dimensional DFT base vector.

Embodiment 71: The communication node according to any one of embodiments 67 to 70, the first transmission path is a first-arrival path or a strongest path identified after projection of the DFT base vector, the first positioning measurement reference signal has a lowest transmission delay on the first-arrival path, and the first positioning measurement reference signal has smallest attenuation on the strongest path.

Embodiment 72: The communication node according to any one of embodiments 67 to 71, the processing module is further configured to record an arrival moment T4 of the second positioning measurement reference signal, and measure an angle of arrival AOA2 of the second positioning measurement reference signal.

Embodiment 73: The communication node according to embodiment 72, the processing module is further further configured to record a sending moment T1 of the first positioning measurement reference signal, and/or measure an angle of departure AOD2 of the first positioning measurement reference signal.

Embodiment 74: The communication node according to embodiment 73, the sending module is further configured to send fourth positioning information to a location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 75: The communication node according to any one of embodiments 67 to 74, the first indication information is carried in channel state information.

Embodiment 76: The communication node according to embodiment 75, the channel state information further includes but is not limited to PMI information, CQI information, and RI information of a channel matrix.

Embodiment 77: A communication node, including a receiving module configured to receive third positioning information sent by a to-be-positioned node and fourth positioning information sent by a reference node, where the third positioning information and the fourth positioning information respectively include positioning information obtained by the to-be-positioned node based on a first transmission path and positioning information obtained by the reference node based on the first transmission path, or the third positioning information and the fourth positioning information respectively include positioning information obtained by the to-be-positioned node based on same first intermediate information and positioning information obtained by the reference node based on the same first intermediate information, and the first intermediate information includes a DFT base vector, and a processing module configured to position the to-be-positioned node based on the third positioning information and the fourth positioning information.

Embodiment 78: The communication node according to embodiment 77, the third positioning information includes first time information, or the third positioning information includes first time information and first angle information, where the first time information includes an arrival moment T2 of a first positioning measurement reference signal and a sending moment T3 of a second positioning measurement reference signal, or a difference T3−T2 between the sending moment T3 of the second positioning measurement reference signal and the arrival moment T2 of the first positioning measurement reference signal, where the first positioning measurement reference signal is sent by the reference node, and the second positioning measurement reference signal is sent by the to-be-positioned node, and the first angle information includes an angle of arrival AOA1 of the first positioning measurement reference signal, and/or an angle of departure AOD1 of the second positioning measurement reference signal.

Embodiment 79: The communication node according to embodiment 78, the fourth positioning information includes second time information, or the fourth positioning information includes second time information and second angle information, where the second time information includes an arrival moment T4 of the second positioning measurement reference signal and a sending moment T1 of the first positioning measurement reference signal, or a difference T4−T1 between the arrival moment T4 of the second positioning measurement reference signal and the sending moment T1 of the first positioning measurement reference signal, where the first positioning measurement reference signal is sent by the reference node, and the second positioning measurement reference signal is sent by the to-be-positioned node, and the second angle information includes an angle of arrival AOA2 of the second positioning measurement reference signal, and/or an angle of departure AOD2 of the first positioning measurement reference signal.

Embodiment 80: The communication node according to embodiment 79, the processing module is further configured to determine a round trip time based on the first time information and the second time information, calculate the positioning information of the to-be-positioned node based on the round trip time, the AOA1 in the first angle information, and the AOD2 in the second angle information, calculate the positioning information of the to-be-positioned node based on the round trip time, the AOD1 in the first angle information, and the AOA2 in the second angle information, calculate the positioning information of the to-be-positioned node based on the round trip time, a weighted value of the AOA1 and the AOD1 in the first angle information, and the AOA2 in the second angle information, calculate the positioning information of the to-be-positioned node based on the round trip time, the weighted value of the AOA1 and the AOD1 in the first angle information, and the AOD2 in the second angle information, calculate the positioning information of the to-be-positioned node based on the round trip time, the weighted value of the AOA1 and the AOD1 in the first angle information, and a weighted value of the AOA2 and the AOD2 in the second angle information, calculate the positioning information of the to-be-positioned node based on the round trip time, the AOA1 in the first angle information, and the weighted value of the AOA2 and the AOD2 in the second angle information, or calculate the positioning information of the to-be-positioned node based on the round trip time, the AOD1 in the first angle information, and the weighted value of the AOA2 and the AOD2 in the second angle information.

Embodiment 81: A communication apparatus, including at least one processor, a communication interface, and a memory, where the communication interface is used for information exchange between the communication apparatus and another communication apparatus, the memory stores computer program instructions, and when the computer program instructions are executed by the at least one processor, the communication apparatus is enabled to implement the following steps: receiving a first positioning measurement reference signal transmitted through N transmission paths, where the first positioning measurement reference signal is sent by a reference node, and N is an integer greater than 1, measuring first positioning information based on the first positioning measurement reference signal on a first transmission path, where the first transmission path is one of the N transmission paths, and sending first indication information and a second positioning measurement reference signal to the reference node, where the first indication information is used to indicate the first transmission path, so that the reference node measures second positioning information on the first transmission path.

Embodiment 82: The communication apparatus according to embodiment 81, the first transmission path is a first-arrival path or a strongest path, the first positioning measurement reference signal has a lowest transmission delay on the first-arrival path, the first positioning measurement reference signal has smallest attenuation on the strongest path, and when the computer program instructions are executed by the at least one processor, the communication apparatus is enabled to implement the following steps: determining the first transmission path based on a transmission delay and/or a signal power of the first positioning measurement reference signal.

Embodiment 83: The communication apparatus according to embodiment 82, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 84: The communication apparatus according to any one of embodiments 81 to 83, when the computer program instructions are executed by the at least one processor, the communication apparatus is enabled to implement the following steps: recording an arrival moment T2 of the first positioning measurement reference signal, and measuring an angle of arrival AOA1 of the first positioning measurement reference signal.

Embodiment 85: The communication apparatus according to embodiment 84, when the computer program instructions are executed by the at least one processor, the communication apparatus is enabled to implement the following steps: recording a sending moment T3 of the second positioning measurement reference signal, and/or measuring an angle of departure AOD1 of the second positioning measurement reference signal.

Embodiment 86: The communication apparatus according to embodiment 85, when the computer program instructions are executed by the at least one processor, the communication apparatus is enabled to implement the following step: sending third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 87: The communication apparatus according to any one of embodiments 81 to 86, the first indication information is carried in channel state information.

Embodiment 88: The communication apparatus according to embodiment 87, the channel state information further includes but is not limited to: PMI information, CQI information, and RI information of a channel matrix.

Embodiment 89: A communication apparatus, including at least one processor, a communication interface, and a memory, where the communication interface is used for information exchange between the communication apparatus and another communication apparatus, the memory stores computer program instructions, and when the computer program instructions are executed by the at least one processor, the communication apparatus is enabled to implement the following steps: sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate a first transmission path, and the first transmission path is one of the N transmission paths, and measuring second positioning information on the first transmission path based on the first indication information.

Embodiment 90: The communication apparatus according to embodiment 89, the first transmission path is a first-arrival path or a strongest path, the first positioning measurement reference signal has a lowest transmission delay on the first-arrival path, and the first positioning measurement reference signal has smallest attenuation on the strongest path.

Embodiment 91: The communication apparatus according to embodiment 90, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 92: The communication apparatus according to any one of embodiments 89 to 91, when the computer program instructions are executed by the at least one processor, the communication apparatus is enabled to implement the following steps: recording an arrival moment T4 of the second positioning measurement reference signal, and measuring an angle of arrival AOA2 of the second positioning measurement reference signal.

Embodiment 93: The communication apparatus according to embodiment 92, when the computer program instructions are executed by the at least one processor, the communication apparatus is enabled to implement the following steps: recording a sending moment T1 of the first positioning measurement reference signal, and/or measuring an angle of departure AOD2 of the first positioning measurement reference signal.

Embodiment 94: The communication apparatus according to embodiment 93, when the computer program instructions are executed by the at least one processor, the communication apparatus is enabled to implement the following step: sending fourth positioning information to a location service node, where the fourth positioning information includes second time information, or the fourth positioning information includes second time information and second angle information, where the second time information includes: the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 95: The communication apparatus according to any one of embodiments 89 to 94, the first indication information is carried in channel state information.

Embodiment 96: The communication apparatus according to embodiment 95, the channel state information further includes but is not limited to: PMI information, CQI information, and RI information of a channel matrix.

Embodiment 97: A communication apparatus, including at least one processor, a communication interface, and a memory, where the communication interface is used for information exchange between the communication apparatus and another communication apparatus, the memory stores computer program instructions, and when the computer program instructions are executed by the at least one processor, the communication apparatus is enabled to implement the following steps: receiving a first positioning measurement reference signal transmitted through N transmission paths, where the first positioning measurement reference signal is sent by a reference node, and N is an integer greater than 1, measuring first positioning information based on first intermediate information, where the first intermediate information includes a DFT base vector corresponding to a first transmission path in a precoding submatrix, and the first transmission path is one of the N transmission paths, and sending first indication information and a second positioning measurement reference signal to the reference node, where the first indication information is used to indicate the first intermediate information, so that the reference node measures second positioning information based on the first intermediate information indicated by the first indication information.

Embodiment 98: The communication apparatus according to embodiment 97, that the first indication information is used to indicate the first intermediate information includes the first indication information includes identification information of the DFT base vector corresponding to the first transmission path in the precoding submatrix.

Embodiment 99: The communication apparatus according to embodiment 98, that the first indication information includes identification information of the DFT base vector corresponding to the first transmission path in the precoding submatrix includes the first indication information includes index information of the DFT base vector.

Embodiment 100: The communication apparatus according to embodiment 98 or 99, the precoding submatrix is a submatrix including a frequency domain DFT base vector, or the precoding submatrix is a submatrix including a spatial domain and frequency domain two-dimensional DFT base vector.

Embodiment 101: The communication apparatus according to any one of embodiments 97 to 100, the first transmission path is a first-arrival path or a strongest path identified after projection of the DFT base vector, the first positioning measurement reference signal has a lowest transmission delay on the first-arrival path, the first positioning measurement reference signal has smallest attenuation on the strongest path, and when the computer program instructions are executed by the at least one processor, the communication apparatus is enabled to implement the following step: determining the first transmission path based on a transmission delay and/or a signal power of the first positioning measurement reference signal.

Embodiment 102: The communication apparatus according to any one of embodiments 97 to 101, when the computer program instructions are executed by the at least one processor, the communication apparatus is enabled to implement the following steps: recording an arrival moment T2 of the first positioning measurement reference signal, and measuring an angle of arrival AOA1 of the first positioning measurement reference signal.

Embodiment 103: The communication apparatus according to embodiment 102, when the computer program instructions are executed by the at least one processor, the communication apparatus is enabled to implement the following steps: recording a sending moment T3 of the second positioning measurement reference signal, and/or measuring an angle of departure AOD1 of the second positioning measurement reference signal.

Embodiment 104: The communication apparatus according to embodiment 103, when the computer program instructions are executed by the at least one processor, the communication apparatus is enabled to implement the following step: sending third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 105: The communication apparatus according to any one of embodiments 97 to 104, the first indication information is carried in channel state information.

Embodiment 106: The communication apparatus according to embodiment 105, the channel state information further includes but is not limited to: PMI information, CQI information, and RI information of a channel matrix.

Embodiment 107: A communication apparatus, including at least one processor, a communication interface, and a memory, where the communication interface is used for information exchange between the communication apparatus and another communication apparatus, the memory stores computer program instructions, and when the computer program instructions are executed by the at least one processor, the communication apparatus is enabled to implement the following steps: sending a first positioning measurement reference signal, where the first positioning measurement reference signal is transmitted to a to-be-positioned node through N transmission paths, and N is an integer greater than 1, receiving first indication information and a second positioning measurement reference signal that are sent by the to-be-positioned node, where the first indication information is used to indicate first intermediate information, the first intermediate information includes a DFT base vector corresponding to a first transmission path in a precoding submatrix, and the first transmission path is one of the N transmission paths, and measuring second positioning information based on the first indication information by using the first intermediate information.

Embodiment 108: The communication apparatus according to embodiment 107, that the first indication information is used to indicate the first intermediate information includes the first indication information includes identification information of the DFT base vector corresponding to the first transmission path in the precoding submatrix.

Embodiment 109: The communication apparatus according to embodiment 107 or 108, that the first indication information is used to indicate the first intermediate information includes the first indication information includes index information of the DFT base vector.

Embodiment 110: The communication apparatus according to embodiment 108 or 109, the precoding submatrix is a submatrix including a frequency domain DFT base vector, or the precoding submatrix is a submatrix including a spatial domain and frequency domain two-dimensional DFT base vector.

Embodiment 111: The communication apparatus according to any one of embodiments 107 to 110, the first transmission path is a first-arrival path or a strongest path identified after projection of the DFT base vector, the first positioning measurement reference signal has a lowest transmission delay on the first-arrival path, and the first positioning measurement reference signal has smallest attenuation on the strongest path.

Embodiment 112: The communication apparatus according to any one of embodiments 107 to 111, when the computer program instructions are executed by the at least one processor, the communication apparatus is enabled to implement the following steps: recording an arrival moment T4 of the second positioning measurement reference signal, and measuring an angle of arrival AOA2 of the second positioning measurement reference signal.

Embodiment 113: The communication apparatus according to embodiment 112, when the computer program instructions are executed by the at least one processor, the communication apparatus is enabled to implement the following steps: recording a sending moment T1 of the first positioning measurement reference signal, and/or measuring an angle of departure AOD2 of the first positioning measurement reference signal.

Embodiment 114: The communication apparatus according to embodiment 113, when the computer program instructions are executed by the at least one processor, the communication apparatus is enabled to implement the following step: sending fourth positioning information to a location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 115: The communication apparatus according to any one of embodiments 107 to 114, the first indication information is carried in channel state information.

Embodiment 116: The communication apparatus according to embodiment 115, the channel state information further includes but is not limited to: PMI information, CQI information, and RI information of a channel matrix.

Embodiment 117: A communication apparatus, including at least one processor, a communication interface, and a memory, where the communication interface is used for information exchange between the communication apparatus and another communication apparatus, the memory stores computer program instructions, and when the computer program instructions are executed by the at least one processor, the communication apparatus is enabled to implement the following steps: receiving third positioning information sent by a to-be-positioned node and fourth positioning information sent by a reference node, where the third positioning information and the fourth positioning information respectively include positioning information obtained by the to-be-positioned node based on a first transmission path and positioning information obtained by the reference node based on the first transmission path, or the third positioning information and the fourth positioning information respectively include positioning information obtained by the to-be-positioned node based on same first intermediate information and positioning information obtained by the reference node based on the same first intermediate information, and the first intermediate information includes a DFT base vector, and positioning the to-be-positioned node based on the third positioning information and the fourth positioning information.

Embodiment 118: The communication apparatus according to embodiment 117, the third positioning information includes first time information, or the third positioning information includes first time information and first angle information, where the first time information includes an arrival moment T2 of a first positioning measurement reference signal and a sending moment T3 of a second positioning measurement reference signal, or a difference T3−T2 between the sending moment T3 of the second positioning measurement reference signal and the arrival moment T2 of the first positioning measurement reference signal, where the first positioning measurement reference signal is sent by the reference node, and the second positioning measurement reference signal is sent by the to-be-positioned node, and the first angle information includes an angle of arrival AOA1 of the first positioning measurement reference signal, and/or an angle of departure AOD1 of the second positioning measurement reference signal.

Embodiment 119: The communication apparatus according to embodiment 118, the fourth positioning information includes second time information, or the fourth positioning information includes second time information and second angle information, where the second time information includes an arrival moment T4 of the second positioning measurement reference signal and a sending moment T1 of the first positioning measurement reference signal, or a difference T4−T1 between the arrival moment T4 of the second positioning measurement reference signal and the sending moment T1 of the first positioning measurement reference signal, where the first positioning measurement reference signal is sent by the reference node, and the second positioning measurement reference signal is sent by the to-be-positioned node, and the second angle information includes an angle of arrival AOA2 of the second positioning measurement reference signal, and/or an angle of departure AOD2 of the first positioning measurement reference signal.

Embodiment 120: The communication apparatus according to embodiment 119, when the computer program instructions are executed by the at least one processor, the communication apparatus is enabled to implement the following steps: determining a round trip time based on the first time information and the second time information, calculating the positioning information of the to-be-positioned node based on the round trip time, the AOA1 in the first angle information, and the AOD2 in the second angle information, calculating the positioning information of the to-be-positioned node based on the round trip time, the AOD1 in the first angle information, and the AOA2 in the second angle information, calculating the positioning information of the to-be-positioned node based on the round trip time, a weighted value of the AOA1 and the AOD1 in the first angle information, and the AOA2 in the second angle information, calculating the positioning information of the to-be-positioned node based on the round trip time, the weighted value of the AOA1 and the AOD1 in the first angle information, and the AOD2 in the second angle information, calculate the positioning information of the to-be-positioned node based on the round trip time, the weighted value of the AOA1 and the AOD1 in the first angle information, and a weighted value of the AOA2 and the AOD2 in the second angle information, calculate the positioning information of the to-be-positioned node based on the round trip time, the AOA1 in the first angle information, and the weighted value of the AOA2 and the AOD2 in the second angle information, or calculate the positioning information of the to-be-positioned node based on the round trip time, the AOD1 in the first angle information, and the weighted value of the AOA2 and the AOD2 in the second angle information.

Embodiment 121: A communication system, including a to-be-positioned node and a reference node, where the reference node is configured to send a first positioning measurement reference signal, the first positioning measurement reference signal is transmitted to the to-be-positioned node through N transmission paths, and N is an integer greater than 1, the to-be-positioned node is configured to receive the first positioning measurement reference signal transmitted through the N transmission paths, measure first positioning information based on the first positioning measurement reference signal on a first transmission path, where the first transmission path is one of the N transmission paths, and send first indication information and a second positioning measurement reference signal to the reference node, where the first indication information is used to indicate the first transmission path, so that the reference node measures second positioning information on the first transmission path, and the reference node is further configured to receive the first indication information and the second positioning measurement reference signal that are sent by the to-be-positioned node, where the first indication information is used to indicate the first transmission path, and the first transmission path is one of the N transmission paths, and measure the second positioning information on the first transmission path based on the first indication information.

Embodiment 122: The communication system according to embodiment 121, the first transmission path is a first-arrival path or a strongest path, where the first positioning measurement reference signal has a lowest transmission delay on the first-arrival path, the first positioning measurement reference signal has smallest attenuation on the strongest path, and the to-be-positioned node is further configured to determine the first transmission path based on a transmission delay and/or a signal power of the first positioning measurement reference signal.

Embodiment 123: The communication system according to embodiment 121 or 122, that the first indication information is represented by 1-bit information, and the first indication information is used to indicate information about the first transmission path includes: when the first transmission path is the first-arrival path, the first indication information is 1, and when the first transmission path is the strongest path, the first indication information is 0, or when the first transmission path is the first-arrival path, the first indication information is 0, and when the first transmission path is the strongest path, the first indication information is 1.

Embodiment 124: The communication system according to any one of embodiments 121 to 123, the to-be-positioned node is further configured to: record an arrival moment T2 of the first positioning measurement reference signal, and measure an angle of arrival AOA1 of the first positioning measurement reference signal.

Embodiment 125: The communication system according to any one of embodiments 121 to 124, the to-be-positioned node is further configured to record a sending moment T3 of the second positioning measurement reference signal, and/or measure an angle of departure AOD1 of the second positioning measurement reference signal.

Embodiment 126: The communication system according to any one of embodiments 121 to 125, the reference node is further configured to record an arrival moment T4 of the second positioning measurement reference signal, and measure an angle of arrival AOA2 of the second positioning measurement reference signal.

Embodiment 127: The communication system according to any one of embodiments 121 to 126, the reference node is further configured to record a sending moment T1 of the first positioning measurement reference signal, and/or measure an angle of departure AOD2 of the first positioning measurement reference signal.

Embodiment 128: The communication system according to any one of embodiments 121 to 127, the to-be-positioned node is further configured to send third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 129: The communication system according to any one of embodiments 121 to 128, the reference node is further configured to send fourth positioning information to the location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 130: The communication system according to any one of embodiments 121 to 129, the first indication information is carried in channel state information.

Embodiment 131: The communication system according to any one of embodiments 121 to 130, the channel state information further includes but is not limited to: PMI information, CQI information, and RI information of a channel matrix.

Embodiment 132: A communication system, including a to-be-positioned node and a reference node, where the reference node is configured to send a first positioning measurement reference signal, the first positioning measurement reference signal is transmitted to the to-be-positioned node through N transmission paths, and N is an integer greater than 1, the to-be-positioned node is configured to receive the first positioning measurement reference signal transmitted through the N transmission paths, measure first positioning information based on first intermediate information, where the first intermediate information includes a DFT base vector corresponding to a first transmission path in a precoding submatrix, and the first transmission path is one of the N transmission paths, and send first indication information and a second positioning measurement reference signal to the reference node, where the first indication information is used to indicate the first intermediate information, so that the reference node measures second positioning information based on the first intermediate information indicated by the first indication information, and the reference node is further configured to receive the first indication information and the second positioning measurement reference signal that are sent by the to-be-positioned node, where the first indication information is used to indicate first intermediate information, the first intermediate information includes the DFT base vector corresponding to the first transmission path in the precoding submatrix, and the first transmission path is one of the N transmission paths, and measure the second positioning information based on the first indication information by using the first intermediate information.

Embodiment 133: The communication system according to embodiment 132, that the first indication information is used to indicate the first intermediate information includes the first indication information includes identification information of the DFT base vector corresponding to the first transmission path in the precoding submatrix.

Embodiment 134: The communication system according to embodiment 132 or 133, that the first indication information includes identification information of the DFT base vector corresponding to the first transmission path in the precoding submatrix includes the first indication information includes index information of the DFT base vector.

Embodiment 135: The communication system according to any one of embodiments 132 to 134, the precoding submatrix is a submatrix including a frequency domain DFT base vector, or the precoding submatrix is a submatrix including a spatial domain and frequency domain two-dimensional DFT base vector.

Embodiment 136: The communication system according to any one of embodiments 132 to 135, the first transmission path is a first-arrival path or a strongest path identified after projection of the DFT base vector, the first positioning measurement reference signal has a lowest transmission delay on the first-arrival path, the first positioning measurement reference signal has smallest attenuation on the strongest path, and the to-be-positioned node is further configured to determine the first transmission path based on a transmission delay and/or signal power of the first positioning measurement reference signal.

Embodiment 137: The communication system according to any one of embodiments 132 to 136, the to-be-positioned node is further configured to record an arrival moment T2 of the first positioning measurement reference signal, and measure an angle of arrival AOA1 of the first positioning measurement reference signal.

Embodiment 138: The communication system according to any one of embodiments 132 to 137, the to-be-positioned node is further configured to record a sending moment T3 of the second positioning measurement reference signal, and/or measure an angle of departure AOD1 of the second positioning measurement reference signal.

Embodiment 139: The communication system according to any one of embodiments 132 to 138, the reference node is further configured to record an arrival moment T4 of the second positioning measurement reference signal, and measure an angle of arrival AOA2 of the second positioning measurement reference signal.

Embodiment 140: The communication system according to any one of embodiments 132 to 139, the reference node is further configured to record a sending moment T1 of the first positioning measurement reference signal, and/or measure an angle of departure AOD2 of the first positioning measurement reference signal.

Embodiment 141: The communication system according to any one of embodiments 132 to 140, the to-be-positioned node is further configured to send third positioning information to a location service node, where the third positioning information includes first time information, or the third positioning information includes first time information and first angle information, where the first time information includes the arrival moment T2 of the first positioning measurement reference signal and the sending moment T3 of the second positioning measurement reference signal, or a difference T3−T2 between the sending moment T3 of the second positioning measurement reference signal and the arrival moment T2 of the first positioning measurement reference signal, and the first angle information includes the angle of arrival AOA1 of the first positioning measurement reference signal, and/or the angle of departure AOD1 of the second positioning measurement reference signal.

Embodiment 142: The communication system according to any one of embodiments 132 to 141, the reference node is further configured to send fourth positioning information to the location service node, where the fourth positioning information includes second time information, or the fourth positioning information includes second time information and second angle information, where the second time information includes the arrival moment T4 of the second positioning measurement reference signal and the sending moment T1 of the first positioning measurement reference signal, or a difference T4−T1 between the arrival moment T4 of the second positioning measurement reference signal and the sending moment T1 of the first positioning measurement reference signal, and the second angle information includes the angle of arrival AOA2 of the second positioning measurement reference signal, and/or the angle of departure AOD2 of the first positioning measurement reference signal.

Embodiment 143: The communication system according to any one of embodiments 132 to 142, the first indication information is carried in channel state information.

Embodiment 144: The communication system according to any one of embodiments 132 to 143, the channel state information further includes but is not limited to: PMI information, CQI information, and RI information of a channel matrix.

Embodiment 145: The communication system according to any one of embodiments 121 to 143, the communication system further includes the location service node configured to receive third positioning information sent by the to-be-positioned node and fourth positioning information sent by the reference node, where the third positioning information and the fourth positioning information respectively include positioning information obtained by the to-be-positioned node based on a first transmission path and positioning information obtained by the reference node based on the first transmission path, or the third positioning information and the fourth positioning information respectively include positioning information obtained by the to-be-positioned node based on same first intermediate information and positioning information obtained by the reference node based on the same first intermediate information, and the first intermediate information includes the DFT base vector, and position the to-be-positioned node based on the third positioning information and the fourth positioning information.

Embodiment 146: The communication system according to embodiment 145, the location service node is further configured to determine a round trip time based on the first time information and the second time information, calculate the positioning information of the to-be-positioned node based on the round trip time, the AOA1 in the first angle information, and the AOD2 in the second angle information, calculate the positioning information of the to-be-positioned node based on the round trip time, the AOD1 in the first angle information, and the AOA2 in the second angle information, calculate the positioning information of the to-be-positioned node based on the round trip time, a weighted value of the AOA1 and the AOD1 in the first angle information, and the AOA2 in the second angle information, calculate the positioning information of the to-be-positioned node based on the round trip time, the weighted value of the AOA1 and the AOD1 in the first angle information, and the AOD2 in the second angle information, calculate the positioning information of the to-be-positioned node based on the round trip time, the weighted value of the AOA1 and the AOD1 in the first angle information, and a weighted value of the AOA2 and the AOD2 in the second angle information, calculate the positioning information of the to-be-positioned node based on the round trip time, the AOA1 in the first angle information, and the weighted value of the AOA2 and the AOD2 in the second angle information, or calculate the positioning information of the to-be-positioned node based on the round trip time, the AOD1 in the first angle information, and the weighted value of the AOA2 and AOD2 in the second angle information.

Embodiment 147: A computer program product, where when the computer program product runs on a computer, the computer is enabled to perform the method according to any one of embodiment 1 to embodiment 40.

Embodiment 148: A computer-readable storage medium is provided, where the computer-readable storage medium stores instructions, and when the instructions are run on a computer, the computer is enabled to perform the method according to any one of embodiment 1 to embodiment 40.

Embodiment 149: A chip, where the chip includes a processor, and when the processor executes instructions, the processor is configured to perform the method according to any one of embodiment 1 to embodiment 40. The instructions may be from a memory inside the chip, or may be from a memory outside the chip. Optionally, the chip further includes an input/output circuit.

The communication node, the communication apparatus, the computer storage medium, the computer program product, and the chip provided in embodiments of this disclosure are all configured to perform the methods provided above. Therefore, for beneficial effects that can be achieved by the image generation apparatus, the terminal device, the computer storage medium, the computer program product, and the chip, refer to the beneficial effects corresponding to the methods provided above. Details are not described herein again.

All or some of the foregoing embodiments may be implemented by using software, hardware, firmware, or any combination thereof. When software is used to implement embodiments, all or some of embodiments may be implemented in a form of a computer program product. The computer program product includes one or more computer instructions. When the computer program instructions are loaded and executed on the computer, the procedure or functions according to embodiments of this disclosure are all or partially generated. The computer may be a general-purpose computer, a dedicated computer, a computer network, or other programmable apparatuses. The computer instructions may be stored in a computer-readable storage medium, or may be transmitted by using the computer-readable storage medium. The computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DIGITAL VERSATILE DISC (DVD)), a semiconductor medium (for example, a solid-state drive (SSD)), or the like.

A person of ordinary skill in the art may understand that all or some of the processes of the methods in embodiments may be implemented by a computer program instructing relevant hardware. The program may be stored in a computer-readable storage medium. When the program runs, the processes of the methods in embodiments are performed. The foregoing storage medium includes any medium that can store program code, such as a read-only memory (ROM), a random-access memory (RAM), a magnetic disk, or an optical disc.

The foregoing descriptions are merely specific implementations of embodiments of this disclosure, but are not intended to limit the protection scope of embodiments of this disclosure. Any variation or replacement within the technical scope disclosed in embodiments of this disclosure shall fall within the protection scope of embodiments of this disclosure. Therefore, the protection scope of embodiments of this disclosure shall be subject to the protection scope of the claims.

1. A method implemented by a user equipment (UE) node, wherein the method comprises:
receiving a first positioning measurement reference signal from a reference node and through N transmission paths, wherein N is an integer greater than one;
measuring, on a first transmission path, first positioning information based on the first positioning measurement reference signal, wherein the first transmission path is one of the N transmission paths; and
sending first indication information and a second positioning measurement reference signal to the reference node,
wherein the first indication information indicates the first transmission path and enables the reference node to measure second positioning information on the first transmission path.

2. The method of claim 1, wherein the first transmission path is a first-arrival path or a strongest path, wherein the first positioning measurement reference signal has a lowest transmission delay on the first-arrival path, wherein the first positioning measurement reference signal has a smallest attenuation on the strongest path, and wherein the method further comprises determining the first transmission path based on a transmission delay or a signal power of the first positioning measurement reference signal.

3. The method of claim 2, wherein that the first indication information comprises one-bit information, and wherein the first indication information is:
one when the first transmission path is the first-arrival path; and
zero when the first transmission path is the strongest path.

4. The method of claim 1, further comprising:
recording an arrival moment (T2) of the first positioning measurement reference signal; and
measuring an angle of arrival (AOA1) of the first positioning measurement reference signal.

5. The method of claim 4, further comprising:
recording a sending moment (T3) of the second positioning measurement reference signal; and
measuring an angle of departure (AOD1) of the second positioning measurement reference signal.

6. The method of claim 1, wherein the first indication information is carried in channel state information.

7. The method of claim 6, wherein the channel state information comprises:
precoding matrix indicator (PMI) information;
channel quality indicator (CQI) information; and
rank indicator (RI) information of a channel matrix.

8. A method implemented by a reference node, wherein the method comprises:
sending a first positioning measurement reference signal to a user equipment (UE) node through N transmission paths, wherein N is an integer greater than one;
receiving first indication information and a second positioning measurement reference signal from the UE node, wherein the first indication information indicates a first transmission path, and wherein the first transmission path is one of the N transmission paths; and
measuring positioning information on the first transmission path based on the first indication information.

9. The method of claim 8, wherein the first transmission path is a first-arrival path or a strongest path, wherein the first positioning measurement reference signal has a lowest transmission delay on the first-arrival path, and wherein the first positioning measurement reference signal has a smallest attenuation on the strongest path.

10. The method of claim 8, further comprising:
recording an arrival moment (T4) of the second positioning measurement reference signal; and
measuring an angle of arrival (AOA2) of the second positioning measurement reference signal.

11. The method of claim 8, wherein the first indication information is carried in channel state information.

12. The method of claim 11, wherein the channel state information comprises:
precoding matrix indicator (PMI) information;
channel quality indicator (CQI) information; and
rank indicator (RI) information of a channel matrix.

13. A method implemented by a location service node, wherein the method comprises:
receiving first positioning information from a user equipment (UE) node, wherein the first positioning information is based on a first transmission path or is based on first intermediate information, and wherein the first intermediate information comprises a discrete Fourier transformation (DFT) base vector;
receiving second positioning information from a reference node, wherein the second positioning information is based on the first transmission path or is based on the first intermediate information; and
positioning the UE node based on the first positioning information and the second positioning information.

14. The method of claim 13, wherein the first positioning information comprises first time information or comprises first time information and first angle information, wherein the first time information comprises:
a first arrival moment (T2) of a first positioning measurement reference signal from the reference node and a first sending moment (T3) of a second positioning measurement reference signal from the UE node; or
a first difference between T3 and T2, and
wherein the first angle information comprises:
a first angle of arrival (AOA1) of the first positioning measurement reference signal; or
a first angle of departure (AOD1) of the second positioning measurement reference signal.

15. The method of claim 14, wherein the fourth second positioning information comprises second time information or comprises second time information and second angle information, wherein the second time information comprises:
a second arrival moment (T4) of the second positioning measurement reference signal and a second sending moment (T1) of the first positioning measurement reference signal; or
a second difference between T4 and T1, and
wherein the second angle information comprises:
a second angle of arrival (AOA2) of the second positioning measurement reference signal; and
a second angle of departure (AOD2) of the first positioning measurement reference signal.

16. A communication user equipment (UE) node comprising:
a memory configured to store instructions; and
a processor coupled to the memory and configured to execute the instructions to cause the UE node to:
receive a first positioning measurement reference signal from a reference node and through N transmission paths, wherein N is an integer greater than one;
measure, on a first transmission path, first positioning information based on the first positioning measurement reference signal, wherein the first transmission path is one of the N transmission paths; and
send first indication information and a second positioning measurement reference signal to the reference node,
wherein the first indication information indicates the first transmission path and enables the reference node to measure second positioning information on the first transmission path.

17.-18. (canceled)

19. The UE node of claim 16, wherein the first transmission path is a first-arrival path or a strongest path, wherein the first positioning measurement reference signal has a lowest transmission delay on the first-arrival path, wherein the first positioning measurement reference signal has a smallest attenuation on the strongest path, and wherein the processor is further configured to execute the instructions to cause the UE node to determine the first transmission path based on a transmission delay or a signal power of the first positioning measurement reference signal.

20. The UE node of claim 19, wherein that the first indication information comprises one-bit information, and wherein the first indication information is:
one when the first transmission path is the first-arrival path; and
zero when the first transmission path is the strongest path.

21. The UE node of claim 19, wherein that the first indication information comprises one-bit information, and wherein the first indication information is:
zero when the first transmission path is the first-arrival path; and
one when the first transmission path is the strongest path.

22. The method of claim 2, wherein that the first indication information comprises one-bit information, and wherein the first indication information is:
zero when the first transmission path is the first-arrival path; and
one when the first transmission path is the strongest path.
